(19) United States
(12) Patent Application Publication
(10) Pub. No.: US 2020/0129978 A1
(43) Pub. Date: Apr. 30, 2020

(54) DEVICES AND METHODS FOR FLOW CONTROL USING ELECTRO-OSMOTIC FLOW

(71) Applicants: TECHNION RESEARCH & DEVELOPMENT FOUNDATION LIMITED, Haifa (IL); INTERNATIONAL BUSINESS MACHINES COPPORATION, Armonk, NY (US)

(72) Inventors: Moran BERCOVICI, Haifa (IL); Federico PARATORE, Haifa (IL); Shimon RUBIN, Haifa (IL); Govind KAIGALA, Pfäffikon (CH); Vesna BACHEVA, Echandens (CH)

(21) Appl. No.: 16/729,885

(22) Filed: Dec. 30, 2019

Related U.S. Application Data
(63) Continuation-in-part of application No. PCT/IL2018/050709, filed on Jun. 28, 2018.
(60) Provisional application No. 62/526,397, filed on Jun. 29, 2017.

(51) Int. Cl. B01L 3/00

(52) U.S. Cl. CPC B01L 3/50273; B01L 2300/12; B01L 2400/0418

(57) ABSTRACT

Disclosed a system comprised of at least one microfluidic chamber configured to contain a liquid containing an electrolyte; a first driving electrode and a second driving electrode arranged at the ends of the chamber and configured to generate a voltage across a fluid volume in the chamber; and a plurality of surface charges, located on a surface layer disposed within or adjacent to the liquid volume. Further disclosed are methods for using the system, e.g., for biological sample analysis.

This application is a Continuation In-Part (CIP) of PCT Patent Application No. PCT/IL2018/050709 having International filing date of Jun. 28, 2018, which claims the benefit of priority of U.S. Provisional Patent Application No. 62/526,397, filed on Jun. 29, 2017. The contents of the above applications are all incorporated by reference as if fully set forth herein in their entirety.

### FIELD OF INVENTION

The present invention, inter alia, relates to: fluidic chambers and assays.

### BACKGROUND OF THE INVENTION

The ability to accurately manipulate fluids in micro platforms is crucial for most microfluidic applications. Fluidic paths are commonly imposed by the geometrical constrains, e.g. physical walls of a microfluidic network, which guide the fluid motion. This allows to design, generate and control the fluidic motion in a precise manner. However, the presence of the physical walls: (i) constrains the fluid in specific regions of the network and (ii) prevents the dynamic modification of the fluidic path.

Electro osmotic flow (EOF) is the fluid motion caused by the viscous interaction between the bulk fluid and the ions in the electric double layer (EDL) moving under an externally applied electric field. The direction and intensity of the EOF velocity is dictated by three parameters: surface charge, electric field and chemical composition of the liquid. For homogenous parameters, the EOF is characterized by a plug-like velocity profile. Variation of the EOF along a microfluidic channel, due to the variation of at least one of the aforementioned parameters, causes the generation of pressure gradients that modify the velocity profile.

### SUMMARY OF THE INVENTION

The present invention provides, in some embodiments thereof, fluidic chambers and methods for using same.

According to one aspect, there is provided a system comprising at least one microfluidic chamber; a first driving electrode and a second driving electrode arranged on opposite ends of the chamber and configured to generate a voltage across a fluid volume in the chamber, the fluid being a liquid comprising an electrolyte; and any one of: (i) one or more gate electrodes; and (ii) a region of a charged material, disposed on or within at least one wall of the microfluidic chamber, so as to provide a plurality of surface charges located within or adjacent to the fluid volume.

In one embodiment, each of the one or more gate electrodes is independently controlled.

In one embodiment, the one or more gate electrodes are in a form of an array of electrodes.

In one embodiment, the system comprises a dielectric layer deposited between the one or more gate electrodes and the fluid volume, wherein the dielectric layer comprises one or more dielectric materials selected from: silicon oxonitride (SiON), silica, alumina, silicon nitride, hafnium oxide, poly(p-xylylene), and poly-dimethylsiloxane (PDMS) or any combination thereof, and wherein the dielectric layer has a thickness of 1 nm to 1 mm.

In one embodiment, the system comprises an alternating current (AC) source in operable communication with (i) the first driving electrode, and with the second driving electrode, and (ii) with the one or more gate electrodes, and wherein the system further comprises a regulator, configured to synchronize the amplitudes of the AC applied to the first and the second driving electrodes and to the one or more gate electrodes.

In one embodiment, the system further comprises a control unit configured to modulate a charge of at least one of the one or more gate electrodes, thus modulating charge distribution on a surface of the fluid.

In one embodiment, the at least one wall comprises a material having an electrical conductivity of less than 1 nS/m, and wherein the at least one wall comprises a material selected from: polydimethylsiloxane (PDMS), polymethyl methacrylate (PMMA), cyclic olefin copolymer (COC), glass, or any combination thereof.

In one embodiment, the charged material comprises one or more materials selected from: a charged self-assembled monolayer, a charged polymer, a charged cross-linked organosilicate; an amino acid, a peptide, a protein, a nucleotide, a nucleoside, DNA, oxidized silicon surface; ceramics, oxides, a conductive layer, and a metal including any combinations or derivates thereof.

In one embodiment, the charged material comprises a polymer selected from epoxy-based polymer, poly(allylamine hydrochloride) (PAH), poly(styrene sulphonate) (PSS), poly(diallyldimethylammonium chloride) (PDDA), branched poly(ethylenimine) (PEI), poly(ethylene glycol) (PEG), and poly-L-lysine (PLL).

In one embodiment, the liquid comprises Newtonian liquid, non-Newtonian liquid, or a combination thereof.

In one embodiment, the first and the second driving electrodes are connected to a source of direct current (DC).

In one embodiment, the fluid has a pH between 3 and 8 and wherein a concentration of the electrolyte within the fluid is less than 100 mM.

In another aspect, there is a method of patterning an electroosmotic flow (EOF), comprising the steps of: (i) providing the system of the invention; and (ii) generating a voltage via the first driving electrode and the second driving electrode so as to provide an electrical field within the liquid; wherein the pattern is determined according to the surface charges, thereby patterning the EOF.

In one embodiment, the pattern is characterized by a linear and/or a non-linear EOF.

In one embodiment, each charge of the plurality of surface charges is independently controlled, thereby predetermining the pattern and/or direction of the EOF.

In one embodiment, the method is for separating a sample comprising plurality of particles, wherein the plurality of particles are characterized by different diffusivity.

Unless otherwise defined, all technical and/or scientific terms used herein have the same meaning as commonly understood by one of ordinary skill in the art to which the invention pertains.

Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Exemplary embodiments are illustrated in referenced figures. Dimensions of components and features shown in the figures are generally chosen for convenience and clarity of presentation and are not necessarily shown to scale. The figures are listed below.

FIG. 1 presents a schematic illustration depicting a non-limiting exemplary configuration of the disclosed device.

FIG. 2 presents a schematic illustration depicting a specific non-limiting exemplary configuration of the device, allowing electro osmotic flow (EOF) patterning using non-uniform electric field. An array of electrodes (503) is patterned on one or two surfaces. Each electrode is electrically contacted with external controllers through connection lines (504) and it is independently controlled. The electrodes are in direct contact with the conductive liquid in the microfluidic chamber. Two reservoirs (501, 502) provide the fluidic access to the microfluidic chamber. The potential distribution of the electrodes array results in a specific electric field distribution that allows driving the EOF in the microfluidic chamber.

FIGS. 3A-3B present schematic illustrations depicting a specific non-limiting exemplary configuration of an electrical circuit connection controlling a gate electrode: a schematic top view (FIG. 3A) of the electrical scheme within the device an external pad (402) is connected to the ground (400) through a resistor (401) and to an external power source through a second resistor (403); the microfluidic chamber is also grounded to (400) through an electrode (409) placed in one reservoir (411); the second reservoir (412) is connected through the electrode (404) to an external power source (404); and a schematic lateral view of the electrical scheme (FIG. 3B) within the device showing the external pad is connected to the gate electrode (406) via a connection thread (408).

FIGS. 4A-4D present schematic illustrations depicting a specific non-limiting exemplary configuration of an embodiment of the device for EOF patterning: a schematic top view (“B”) (FIG. 4A) of the device showing a conductive liquid (103) filling the microfluidic chamber formed by the two surfaces (100, 104); two reservoirs (107, 108) ensure the fluidic access to the microfluidic chamber and contain the electrodes (101, 102) for the EOF actuation, and a schematic cross sectional view (“A”) of the device (FIG. 4B), showing the two surfaces (100, 104) containing spots of various dimensions (105a, 105b) having different and/or variable surface charges from the rest of the surfaces; the spots may be on one surface or on both and their sizes and distribution can vary according to a specific application; a schematic cross section (FIG. 4C) of the lateral edge in a non-limiting possible embodiment, the two surfaces (100, 104) are separated by a gasket layer (106) that ensure the sealing of the microfluidic chamber, or in an alternative non-limiting embodiment (FIG. 4D), the top surface (104) is hold by an external mechanical support (109) to a distance “h” from the bottom surface; the liquid (103) is kept inside the microfluidic chamber by capillary forces (107). Dashed lines represents longitudinal axis of the chamber.

FIGS. 5A-5B present schematic illustrations depicting a specific non-limiting exemplary configurations for sealing, fluidic and electric connections: a schematic top view of the device (FIGS. 5A) showing a gasket e.g.., made of poly-dimethylsiloxane (PDMS) (204) having the microfluidic chamber (221) molded is placed in between a top slide (205) and a bottom slide (213); fluidic and electrical access to the microfluidic chamber is provided by two reservoirs (208,209) punched through the PDMS and two holes (222, 223) drilled into the top slide; permanent magnets (200a, 201a, 202a, 203a) are placed onto the top slide; and a schematic view (FIGS. 5B) of a cross section of the device (The adequate sealing of the microfluidic chamber is ensure by placing other permanent magnets (200b, 201b, 202b, 203b) on the bottom of the device, creating a magnetic clamp. Gate electrodes (217,212) are patterned on the bottom slide (213), covered by a dielectric layer (214), and electrically connected with external electrodes (216) trough external pads (215).

FIG. 6 presents a non-limiting exemplary schematic illustration of the process for local modification of zeta potential using microfluidic probe (MFP)-based patterning of polyelectrolytes; the substrate is cleaned with acetone, ethanol and is exposed to 1 min of atmospheric plasma (upper right panel (“1”)); poly(allylamine hydrochloride) (PAH), a positively charged polymer, is deposited locally on the substrate, middle right panel (“2”); a schematic illustration of the PAH deposition process using the MFP (right panel, upper left “2a”): the polymer is injected from a central channel, while being aspirated at a higher flow rate from a surrounding ring-shaped channel, resulting in spatial confinement of the polymer at the tip of the MFP probe; at close proximity to a surface, the confined polymer imprints a disk-shaped pattern; raw fluorescence image showing the circular hydrodynamic flow confinement of the fluorescently-labeled polymer during surface patterning (right panel, left figure, “2b”); raw fluorescence image showing the final disk-shaped spot on the substrate, (right panel, right middle figure “2c”); EOF velocity as a function of PAH concentration, as obtained for a fluidic glass/PDMS chamber uniformly coated with PAH (right panel, lower figure “2d”); a minimum concentration of between 100 nM and 500 nM is required to flip the direction of the EOF velocity relative to the native glass/PDMS, with no change to velocity magnitude at lower or higher concentrations; the remaining uncoated surface is coated with PLL-PEG (polylysine grafted with PEG chains) providing an approximately zero surface charge (left panel, “3”).

FIGS. 7A-7B present a non-limiting exemplary schematic illustration of diffusivity-based separation of particles; the top and bottom surfaces of the microfluidic chamber are patterned with stripes (605,606) of opposite surface charges; at time t₀, particle with different diffusivity are placed in a central region of the microfluidic chamber (FIG. 7A); larger particles (607) have a lower diffusivity than smaller particles (609). At time t₁, upon the application of a voltage between the reservoirs, the

EOF is established in the microfluidic chamber (FIG. 7B); the direction of the EOF is opposite over region with opposite surface charge; particles with low diffusivity will move mainly under the effect of the EOF whereas particles with high diffusivity will move mainly under the effect of diffusion and sample regions with different surface charges. The overall motion of the particle with lower diffusivity towards the two reservoirs will be faster than the particle with higher diffusivity, causing their separation.

FIGS. 8A-8B present a non-limiting exemplary schematic illustration of cell communication. At time t0, two cells (707,708) are introduced in the microfluidic chamber and carried by a pressure driven flow (PDF) imposed by the external flow controller which is dominant with respect of the EOF (FIG. 8A); at time t1, when the cells reached the two spots (705, 706) the surface charge is modified on these spots such us EOF opposes the PDF, generating a zero net flow only on the two spots (FIG. 8B). This allow to trap ‘virtually’ the two cells while ensuring a net flow elsewhere.

FIG. 9 presents a schematic illustration of an analyzed configuration, consisting of two parallel plates, separated by a small gap h. The lower and upper plates are each functionalized with an arbitrary zeta potential distribution, ζ_{L}(x,y) and ζ_{U}(x,y), respectively, and a uniform electric field \vec{E}_{∥} is applied to the fluid between the plates.

FIGS. 10A-10D present a comparison of experimental and analytical flow fields generated by a disk with uniform zeta potential (PAH) surrounded by a neutral surface (PLL-PEG); when no external pressure is applied, the flow field takes the shape of a dipole (FIGS. 10A, 10B, respectively). The flow is uniform in the inner region of the circle and two vortices are formed around each of the poles. Here the electric field is ˜7 V/cm. Imposing a pressure gradient of approximately of ˜0.33 mbar/cm stagnates the flow within the disk, and causes the streamlines to curve around it, coinciding with the solution for potential flow around a cylinder (FIGS. 10C, 10D, experimental and analytical results, respectively). The electric field is ˜30 V/cm.

FIGS. 11A-11B Present streamlines of a flow field generated by four disks, with centers placed 1.6 diameters apart; experimental measurements using 250 μm diameter PAH disk surrounded by a PLL-PEG coated surface (FIG. 11A; FIG. 11B presents the analytical results). The flow field can be successfully described using superposition of the individual disks, resulting in multiple stagnation points.

FIGS. 12A-12C present experimental demonstration of the use non-uniform EOF for separation of particles based on diffusivity: raw fluorescence image showing the substrate after deposition of 100 μm width stripes of FITC labeled PAH (FIGS. 12A); the dark strips correspond to native glass. The image is taken in the vicinity of the right reservoir (not shown in the image) which is then filled with 1 μM rhodamine B in 5 mM bistris, 2.5 HCl buffer. Fluorescent image (FIGS. 12B) using a tritc-filter cube. Upon the application of a ˜16 V/cm electric field, rhodamine b is pulled in the channel by the EOF generated by the glass stripes (i.e. the uncoated regions) while the EOF in the PAH coated stripes is pointing towards the reservoirs. Rhodamine B, due to its high diffusivity (4.2·10⁻¹⁰ m²s⁻¹), samples stripes with opposite EOF generating a dispersed yet stationary concentration profile. Nearly-neutral (PLL-PEG coated; (FIGS. 12C) 1 μm fluorescent beads spiked into the right reservoir are advected into the channel only by the EOF generated on the glass stripes. Because the diffusivity of the beads (4.1·10−13 m²s⁻¹) is much smaller than the diffusivity of the rhodamine b, they advect for a significantly longer time before experiencing any returning flow. For clarity, the images in (FIGS. 12B) and (FIGS. 12C) are presented with the PAH stripes highlighted during post-processing.

FIG. 13 presents a schematic illustration of a non-limiting exemplary device composed of a microfluidic chamber, substrate patterned with stripes of different zeta potential, and electrodes immersed in the reservoirs to create an electric filed (lower and middlepanels “a”); an image of the substrate after deposition of FITC-labeled PAH stripes (bright stripes) (upper middle panel, “b”); upon the application of an external electric filed, the patterned stripes (σ₊) generate EOF in the opposite direction the bare glass (σ_) (upper right panel). The average axial velocity of particles injected into the flow is determined by their lateral diffusivity, resulting in their separation.

FIG. 14 presents a graph showing the measurements of electroosmotic mobility of native glass (dashed lines) and PAH coated glass (solid lines) as a function of pH. The optimal working range is at pH between 5 and 7.5, where the absolute value of EOF of both surfaces is maximized. The electroosmotic motilities were measured by monitoring the migration velocity of nearly neutral PEGylated 1-μm beads subjected to a 50 V/cm electric field.

FIGS. 15A-15B present a Monte Carlo simulation results showing the separation of a finite sample composed of cells (red dots) and proteins (blue dots) injected in the channel. The sample injection (FIG. 15A, left panel) is followed by activation of external electric filed and creation of opposite flows. Low-diffusivity species are transported and extracted by advection, while the high-diffusivity species spread out by diffusion (FIG. 15A, right panel). The average concentration profile of the species, normalized by their initial concentration, along the indicated area (grey box), at two times (FIG. 15B).

FIG. 16 presents the working principle of creating opposite flow streamlines using two patterned electrodes covered with a dielectric. Electrode 1 and 2 generate streamlines pointing downward and upward, respectively. In the main channel (middle panel), two external electrodes in direct contact with the liquid drive the electric field inside the channel using a AC squared voltage signal, oscillating between V (left panels) and −V(right panels).

FIG. 17 presents the working principle of creating opposite streamlines using an array of electrodes. Because the potential drops linearly in the main channel (middle panel), each patterned electrode will experience a different bulk potential. Therefore, the amplitude of the ac signal applied to each electrode should also drop linearly (left panel for V<0; right panel for V>0) along the channel.

FIG. 18 presents a non-limiting exemplary embodiment of circuitry to drive a system composed of an array of electrode to create opposite flows. The power supply used to drive the electric field in the main channel is also used to drive the potential AC signal on all the patterned electrodes. The potential drop among the electrodes is generated by a series of potential divider that can be either external or patterned on the surface. The offset between the potential profile in the main channel and the one applied to the electrodes is provided by two external power supplier (U) connected in series with the circuit that drive the electrode array.

FIGS. 19A-19B show images of a device with 8 electrodes (FIG. 19A: 1—connect to Rₑₓₜ; 2—connect to Keithley; (FIG. 19B: 1—resistor, 2—electrode; 3—reservoirs).

FIG. 20 shows snap shot images at show of a working device upon the indicated time (circle and square shows the particles movement at an opposite direction). The flow is observed using 1 um beads as tracer.

FIGS. 21A-21B show snap shot images at show of a working device upon the indicated time at the right direction (FIG. 21A) and left direction (FIG. 21B). The flow is observed using 1 um beads as tracer.

FIG. 22 shows a photographic image of a non-limiting exemplary device (1—chip; 2—connector).

FIG. 23 is a bar graph showing experimental characterization of the breakdown strength (y-axis) in response to a positive or a negative potential applied to different dielectric layers deposited with plasma enhanced chemical vapor deposition (PECVD). (a=500 nm SiO₂, b=500 nm SiNₓ, c=1000 nm SiO₂, d=500 nm SiO₂ and 500 nm SiNₓ*, e=300 nm SiO₂ and 200 nm SiNₓ*, f=200 nm SiO₂* and 300 nm SiNₓ, g=500 nm SiON, h=500 nm SiO₂ formed by polymerization of tetraethyl orthosilicate (TEOS), i=200 nm SiO₂ (TEOS)* and 300 nm SiON.

For the case of two materials, the material indicated with an asterisk forms the layer in direct contact with the metal. The error bars represent the 95% confidence interval of the mean (with at least 10 repetitions).

FIG. 24 shows the time averaged electroosmotic (EO) wall mobility as function of the potential (Δϕ) for different buffers: 10 mM acetic acid/1 mM NaOH (pH 3.8, 1.4e-2 S/m, dashed line) and 10-times diluted PBS (pH 7.4, 2e-1 S/m, continuous line).

FIGS. 25A-25D show analytical predictions and experimental visualization images of flow streamlines generated by a 200 μm-diameter disk-shaped electrode surrounded by a 400 μm outer diameter annulus, for different combinations.

### DETAILED DESCRIPTION OF THE INVENTION

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

According to one aspect, there is provided a device (may also be referred to as “apparatus”, or “system” interchangeably) comprising: at least one chamber; a first driving electrode and a second driving electrode configured to generate a voltage in the chamber, optionally arranged on opposite ends of the container and configured to generate a voltage across a fluid volume in the chamber; a plurality of local charges, located within or adjacent to the fluid volume, wherein optionally each of the surface charge may be independently controlled.

In some embodiments, the local charges provide surface charge distribution. In some embodiments, the local charges provide a non-homogeneous electric double layer.

The term “opposite ends” includes not only end edge positions but also positions in the vicinity of end edge. Optionally, one or more from the first driving electrode and the second driving electrode are fixed. Optionally, one or more from the first driving electrode and the second driving electrode are disposable.

Optionally, one or more from the plurality of local charges are fixed on a surface. Optionally, one or more from the charges are disposable.

The term “local” means in a confined or in a particular region.

Optionally, the depth and position of the peak electric field focus can be adjusted and steered.

Optionally, the electric field is generated by the charges or other origin generating electric activity.

Optionally, the local charges are located or embedded onto on at least one wall of the container.

Optionally, the local charges are located on at least one wall of the container.

Optionally, the charges may interact capacitively with the electrolyte or particles within the fluid.

Optionally, the container is in the form of a chamber.

Optionally, the chamber may contain a fluid comprising an electrolyte. Optionally, the chamber is devoid of an additional microfluidic channel. Optionally, a cross-section of the chamber has a rectangular form. Optionally, the chamber comprises a perimeter wall. Optionally, the chamber comprises a perimeter outer wall and is devoid of an additional inner wall. Optionally, the chamber comprises an outer wall and is devoid of an additional wall. Optionally, the chamber comprises an outer wall and is devoid of an inner wall. Optionally, the perimeter wall has a rectangular form. Optionally, a cross-section of the perimeter wall is substantially rectangular.

The term “chamber”, as used herein, means a natural or artificial enclosed space or cavity known to those of skill in the art. By “enclosed”, it is further meant to refer to at least partially enclosed.

In some embodiments, the chamber has a length in a range between 1 um and 10 cm, between 0.1 um and 10 cm, between 0.1 um and 1 um, between 1 um and 10 um, between 10 um and 100 um, between 10 um and 200 um, between 200 um and 500 um, between 500 um and 1 cm, between 200 um and 800 um, between 0.1 and 1 cm, between 0.1 and 2 cm, between 0.5 and 2 cm, between 0.5 and 10 cm, between 1 and 10 cm, between 1 and 2 cm, between 2 and 5 cm, between 5 and 10 cm, between 3 and 5 cm, between 5 and 7 cm, between 7 and 10 cm, including any range or value therebetween.

In some embodiments, the chamber has a width between 1 and 1000 um, between 1 and 10 um, between 1 and 5 um, between 5 and 10 um, between 10 and 1000 um, between 10 and 50 um, between 50 and 100 um, between 100 and 1000 um, between 100 and 500 um, between 100 and 200 um, between 50 and 500 um, between 50 and 200 um, between 10 and 500 um, including any range or value therebetween.

In some embodiments, the chamber has a width between 0.1 and 100 mm, between 0.1 and 1 mm, between 0.1 and 10 mm, between 1 and 10 mm, between 1 and 100 mm, between 10 and 100 mm, between 10 and 50 mm, between 50 and 100 mm, between 1 and 50 mm, between 0.1 and 20 mm, between 1 and 20 mm, between 1 and 30 mm, between 1 and 80 mm, including any range or value therebetween.

In some embodiments, the chamber has a height between 1 and 1000 um, between 1 and 20 um, between 1 and 10 um, between 1 and 100 um, between 1 and 500 um, between 10 and 100um, between 5 and 15 um, between 5 and 20 um, between 20 and 50 um, between 50 and 100 um, between 100 and 1000 um, between 10 and 200 um, between 100 and 200 um, between 100 and 300 um, between 300 and 500 um, including any range or value therebetween.

In some embodiments, ratio of a width to a length of the chamber is between 1:1 and 1:10000, between 1:1 and 1:5, between 1:1 and 1:10, between 1:2 and 1:10, between 1:10 and 1:20, between 1:20 and 1:50, between 1:50 and 1:100, between 1:100 and 1:1000, between 1:100 and 1:10000, between 1:100 and 1:500, between 1:500 and 1:1000, between 1:1000 and 1:2000, between 1:2000 and 1:5000, between 1:5000 and 1:10000, including any range or value therebetween.

In some embodiments, a ratio of a median diameter of the electrodes in the array to at least one vertical dimension of the microfluidic chamber is from 1 to 10,000, from 1 to 10, from 1 to 100, from 100 to 500, from 500 to 1000, from 1000 to 2000, from 2000 to 5000, from 5000 to 10,000 including any range or value therebetween.

In some embodiments the chamber is in the form of a chip or a microchip.

The terms “chip”, “microchip”, or “microfluidic chip” as used herein mean that the device has microfluidic form, typically but not exclusively, containing one or more microchannels that may or may not be interconnected with each another.

In some embodiments, the device is biochip.

The term “biochip” is used to define a chip that is used for detection of biochemically relevant parameters from a liquid or gaseous sample. The microfluidic system of the biochip may regulate the motion of the liquids or gases on the biochip and generally may provide flow control with the aim of interaction with the analytical components, such as biosensors, for analysis of the required parameter.

Optionally, the disclosed device is in the form of an integrated lab-on-a-chip e.g., for carrying out a chemical or biological assay for detection of a chemical or biological molecule, respectively, or for determining one or more characteristics of a sample.

The term “lab-on-chip” means an integrated chip on which various scientific operations such as reaction, separation, purification, and detection of sample solution are conducted simultaneously. It is possible to perform ultrahigh-sensitivity analysis, ultratrace-amount analysis, or ultra-flexible simultaneous multi-item analysis by using a lab-on-chip. An example thereof is a chip having a protein-producing unit, a protein-purifying unit, and a protein-detecting unit that are attached to each upon operation of the electric field.

The terms “channel” and “microchannel” are used herein throughout and may comprise or be adjacent to microelectrodes, and/or related control systems.

The term “microchannel” as used herein refers to a groove or plurality of grooves created on a suitable substrate with at least one of, and optionally, all of the dimensions of the groove being, without limitation, in the micrometer range, e.g., 1 μm to 1000 μm. In some embodiments, the height is microsized.

Microchannels may be used as stand-alone units or in conjunction with other microchannels to form a network of channels with a plurality of flow paths and intersections.

The term “microfluidic”, or any grammatical derivative thereof, generally refers to the use of microchannels for transport of liquids or gases. A microfluidic system may include a multitude of microchannels forming a network and associated flow control components such as pumps, valves and filters. Microfluidic systems are ideally suited for controlling minute volumes of liquids or gases. Typically, microfluidic systems can be designed to handle fluid volumes ranging from the picoliter to the milliliter range.

In some embodiments, the term “microfluidic” refers to “smart microfluidic”.

The term “smart microfluidic” implies a microfluidic channel network wherein a certain sequence of microfluidic operations is programmed through the use of a software or structurally programmable microfluidic system.

The term “electrolyte” refers to a substance whose components dissociate in solution into positively and negatively charged ions (cation and anion), and thus the term electrolytic component refers to any such component of an electrolyte.

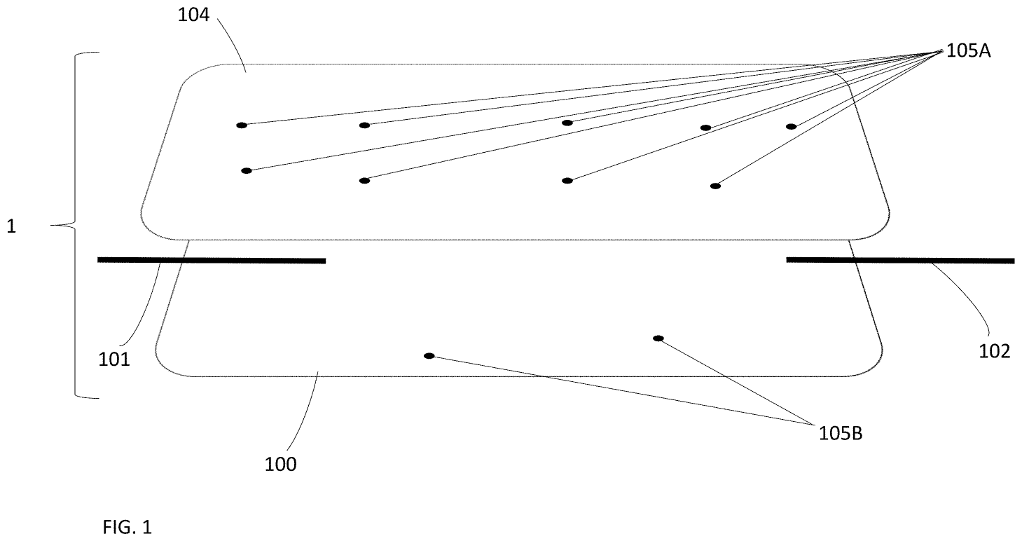

Reference is now made to FIG. 1, which shows a perspective view and a 3D illustration, respectively, of an exemplary device 1.

Device 1 may have a housing. The housing may fully encapsulate elements of device 1 and may be made of a rigid, durable material, such as aluminum, stainless steel, a hard polymer and/or the like. The housing may partially encapsulate elements of device 1. The housing may prevent unwanted foreign elements from entering device 1. Device may be in the form of a chamber or a fluidic chamber. Device 1 may have plates (also referred to as “walls”) 100, 104 as described and exemplified herein, positioned so as to define a volume therebetween, allowing to contain a liquid. Device 1 may have one or more local charges as described herein. In the non-limiting exemplary embodiments depicted in FIG. 1, local charges 105A and 105B are embedded onto plates 104 and/or 110.

Device 1 may have one or more local charges 105A generated by one or more electrodes 105B. The one or more electrodes 105B are in operable communication with a voltage source and may have one or more dielectric materials deposited thereon.

Device 1 may have one or two driving electrodes (also referred to as: “actuation electrodes”) (101, and 102; first driving electrode and second driving electrodes, respectively). First driving electrode 101 and second driving electrode 102 may be arranged on opposite ends of device 1 and configured to generate a voltage across a fluid volume in the container.

In a non-limiting configuration, the charges are provided by an array of electrodes.

Optionally, the array of electrodes have deposited on at least a portion thereof one or more layers of dielectric material, e.g., in the form of a layer.

The term “dielectric layer” as used herein refers to a continuous layer or coating having a finite thickness and a dielectric material having an electrical resistivity exceeding that of a conducting core which the layer encloses. Thus, optionally, the dielectric layer deposited between a surface of the electrode and the container is configured to contact the liquid and, at the same time, may electrically insulate the electrode from the fluid. Optionally, a dielectric layer comprises one or more dielectric materials.

By “a portion” it is meant to refer to, for example, a surface or a portion thereof, and/or a body or a portion thereof, of solid or semi-solid substrates (layers); or a volume or a part thereof. In some embodiments, by “a portion” as used herein throughout, it is meant e.g., at least 1 percent, at least 20 percent, at least 30 percent, at least 40 percent, at least 50 percent, at least 60 percent, at least 70 percent, at least 80 percent, at least 90 percent, and optionally all of the electrode surface comprises dielectric layer, as feasible, including any value therebetween.

Optionally, a dielectric layer patterned on a surface of the electrodes is configured to contact the fluid.

The term “dielectric” (or “dielectric materials”) refers to the broad expanse of nonmetals considered from the standpoint of their interaction with electric, magnetic, or electromagnetic fields such that the materials are capable of storing electric energy. A dielectric material is a substance that is a poor conductor of electricity, but an efficient supporter of electrostatic fields.

Non-limiting examples of dielectric materials contain but are not limited to: silicon oxonitride (SiON), silica, alumina, silicon nitride, hafnium oxide, poly(p-xylylene), and poly-dimethylsiloxane (PDMS) or any combination thereof. Optionally, a dielectric layer comprises a first layer of SiON facing the electrode and an additional dielectric material on top of the first layer.

Optionally, a dielectric layer has a thickness of 1 nm to 1 mm, 1 to 100 nm, 100 to 600 nm, 200 to 600 nm, 300 to 600 nm, 400 to 600 nm, 500 to 600 nm, 450 to 500 nm, 450 to 550 nm, 500 to 550 nm, 500 to 1000 nm, 600 to 1000 nm, 700 to 1000 nm, 800 to 1000 nm, including any range or value therebetween.

Optionally, a dielectric layer is characterized by a similar breakdown behavior in response to a positive and to a negative potential.

Optionally, the electrode in the array is independently configured to carry an electric charge to a surface of the channel (also referred to as “a surface charge”). Optionally, the electric charge is adjustable or controllable by varying the potential of the electrode. Optionally, the electric charge is adjustable or controllable by varying the voltage applied to the electrode. Optionally, the electric charge is adjustable or controllable so as to result in a negative or a positive surface charge. Optionally, each surface charge is adjustable or controllable by varying the potential of the electrode (e.g. the gate electrode).

Optionally, the array of electrodes forms a two dimensional pattern. Optionally, at least one array is aligned perpendicularly to a longitudinal axis of the channel.

Optionally, the device containing two driving electrodes (e.g., first and second electrodes as described above), with the at least one array of electrodes being disposed between the two driving electrodes.

In some embodiments, the electrodes in the array to at least one vertical dimension of the microfluidic chamber is from 1 to 10,000, e.g., 10, 100, 1000, or 10,000, including any value and range therebetween.

As used herein and in the art, the term “electrode” means an electric conductor through which a voltage potential can be measured. An electrode can also be a collector and/or emitter of an electric current. In some embodiments, an electrode is a solid and comprises a conducting metal.

In some embodiments, the electrode is a light pattern electrode. One skilled in the art will recognize that the term “light pattern electrode” may encompass various types of electrodes e.g., as described e.g., in Chiou et al., Nature, Vol. 436, 2005.

In some embodiments, conducting metals include noble metals, alloys and particularly stainless steel and tungsten. An electrode can also be a microwire, or the term “electrode” can describe a collection of microwires.

Herein, the term “array of electrodes” may refer to a single electrode or a plurality of electrodes. The terms “electrodes”, “array of electrodes” or “arrangement of electrodes” do not necessarily refer to any specific geometric arrangement of electrodes .

Non-limiting exemplary electrodes are selected from carbon, gold, silver, nickel, zinc oxide, antimony, bismuth, carbon, iridium, zinc oxide, and platinum. In exemplary embodiments, the electrodes are selected from Pt-Ti and indium tin oxide (ITO).

Optionally, at least one array is aligned along a flow path of a fluid in the chamber. In some embodiments, the fluid is a conductive liquid, wherein the conductive liquid is as described hereinbelow.

Optionally, the two driving electrodes and one or more electrodes in the array are each independently connected to a potential source generating an alternating current (AC). In some embodiments, AC is characterized by a frequency in a range between 1 Hz to 1KHz, between 1 to 10 Hz, between 1 to 100 Hz, between 10 to 100 Hz, between 10 to 50 Hz, between 50 to 100 Hz, between 100 to 1000 Hz, between 200 to 500 Hz, between 1 to 200 Hz, between 10 to 200 Hz, between 20 to 100 Hz, between 20 to 200 Hz, between 20 to 1000 Hz, between 20 to 500 Hz, including any range or value therebetween.

Optionally, the device has a regulator, allowing to synchronize the amplitudes of AC applied to the two driving electrodes and to the one or more electrodes in the array. Thus, the device may have the ability to adjust the applied frequency (AC mode) as well as the voltage (e.g., amplitude). The regulator may produce a predetermined Lorentz force, which, in some embodiments, is generally perpendicular to the direction of fluid flow.

As disclosed in the Example section that follows, an array of electrode may allow create opposite flows. In this non-limiting exemplary configuration, the power supply used to drive the electric field in the main channel may also be used to drive the potential AC signal on all the patterned electrodes. The potential drop among the electrodes may be generated by a series of potential divider that can be either external (ext) or patterned on the surface. Optionally, the offset between the potential profile in the main channel and the one applied to the electrodes may be provided by two external power supplier connected in series with the circuit that drive the electrode array.

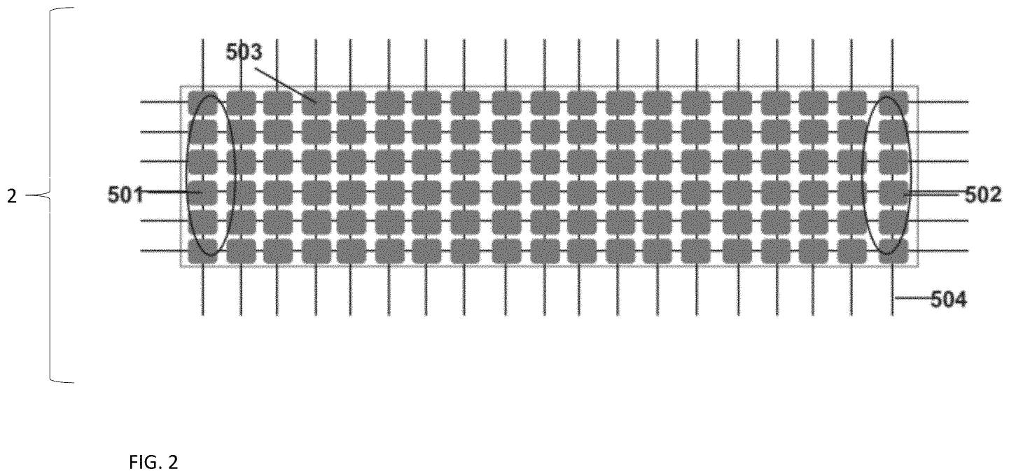

Reference is made to FIG. 2 showing another schematic illustration of the disclosed apparatus in a non-limiting embodiment thereof.

Device 2 may have an array of electrodes 503 forming the local charges as described in FIG. 1. In a non-limiting exemplary configuration the array may be patterned on one or two plates' surfaces defining a channel. Optionally, array of electrode 503 may be electrically contacted with external controllers or electric source through connection lines 504.

Optionally, the electrodes may be in direct or indirect contact with the conductive liquid in the microfluidic chamber. Two reservoirs (adjacent to driving electrodes 501, 502) may provide the fluidic access to the microfluidic chamber. The potential at each electrode attaching the surface (also referred to as “gate electrode”) is independently controlled. The potential distribution of the gate electrodes array may result in a specific electric field distribution that drives the EOF in the microfluidic chamber.

The potential distribution of the gate electrodes array may be dynamically modified, thus controlling the EOF.

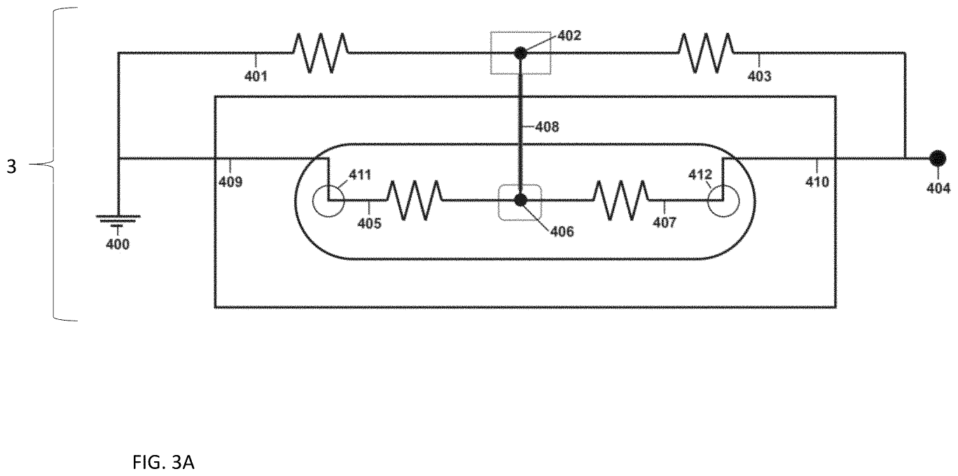

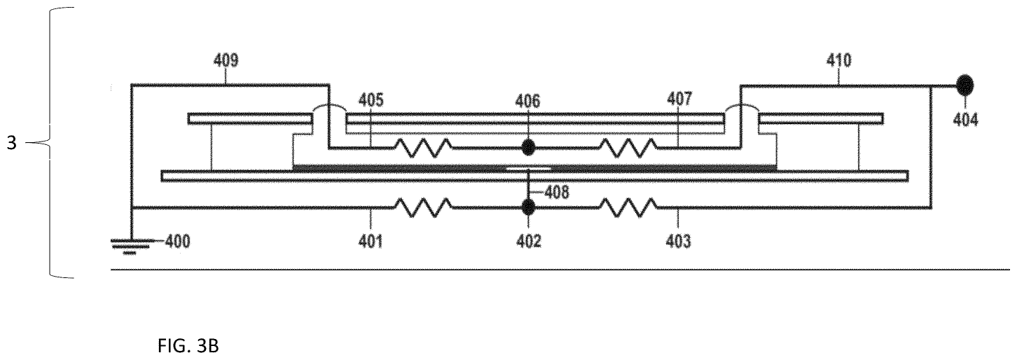

A non-limiting exemplary embodiments showing a schematic illustration of a device (referred to as “device 3”) showing the electrical circuit controlling a gate electrode is shown in FIGS. 3A-B. For simplicity, the description is carried out for one gate electrode with the same electrical considerations being used for multiple gate electrodes.

Device 3 may have an external pad (402) connected to the ground (400) through a resistor (401) and to an external power source through a second resistor (403). The microfluidic chamber is also grounded to (400) through an electrode (409) placed in one reservoir (411). The second reservoir (412) is connected through the electrode (404) to an external power source (404). The external pad is connected to the gate electrode (406) via a connection thread (408).

As the voltage Vₑₓₜ is imposed at the reservoir (412) connected to the power source (404) an electric field E is established within the microfluidic chamber. The distance between the two reservoirs is L. In case of homogeneous liquid, at a distance x from the grounded reservoir (411), the electric potential in the channel V_{c}(x) scales as

$${V}_{c} = \frac{x}{L} {V}_{ext} .$$

The gate electrode is located at a distance x_{g} from the grounded reservoir. The resistors (401, 403) are tuned such as the voltage applied to the gate electrode V_{g} is in the range of, but not limited to,

$${V}_{g} = \frac{{x}_{g}}{L} {V}_{ext} + α .$$

The parameter α is the difference in potential between the liquid on top of the gate electrode and the gate electrode and it can be positive or negative. Importantly, the value V−V_{g} has to be smaller than the voltage that may cause the electric breakdown of the dielectric.

In alternative embodiments, the gate electrode is in direct contact with the liquid and the gate electrode voltage V−V_{g} should be lower than the voltage required for electrochemical reaction to occur. Moreover, defining the length of the gate electrode along the direction of the electric field as g, the voltage drop along the electrode gE needs to be lower than the voltage required for electrochemical reaction to occur.

In another non-limiting configuration, the apparatus comprising: a first layer and a second layer deposited in distance defining a chamber (e.g., microfluidic) chamber, wherein the chamber is configured to contain a fluid comprising an electrolyte; at least two regions on a surface of the first wall and/or on a surface the second wall, each region being configured to provide or to carry a distinct surface local electrical field foci (e.g., a charge, or a zeta potential) and further being configured to contact the fluid.

Optionally, the first and the second driving electrodes, may contact the fluid and further connect to a potential source. Optionally, the first wall and the second walls are substantially parallel to each other. In some embodiments, the two walls form an angle in the range of −15 to 15 degrees with respect to each other.

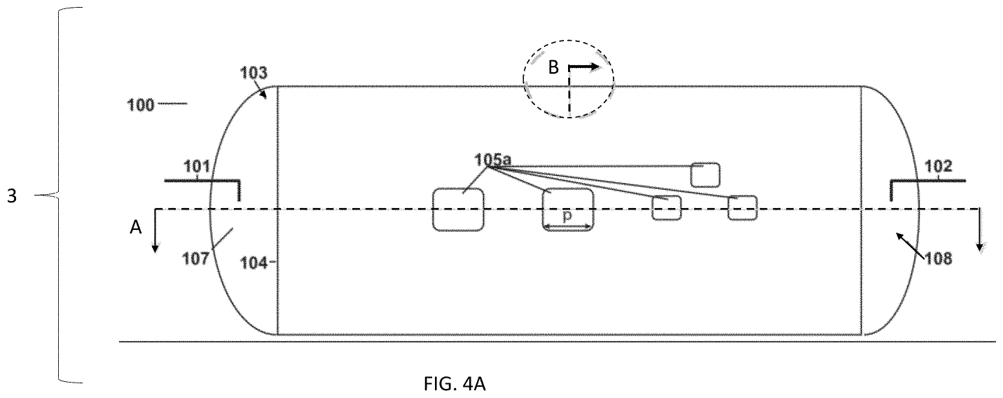

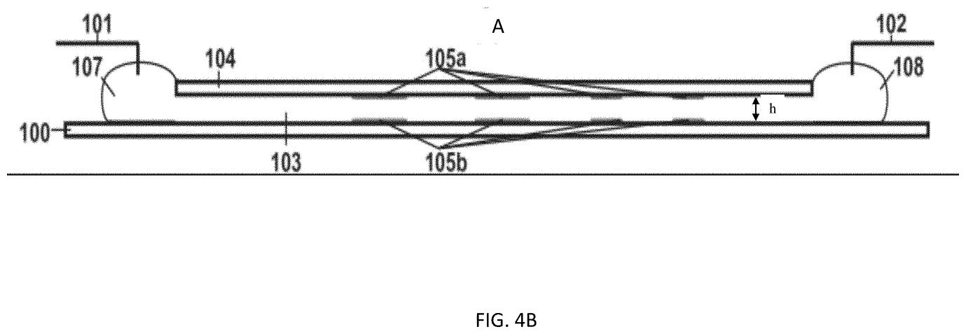

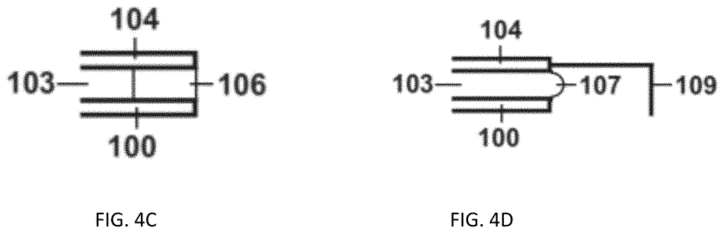

FIGS. 4A-B presents an additional non-limiting exemplary schematic of the device (“device 3”), in a schematic top view of the device (FIG. 4A); and a schematic cross sectional view of the device (FIG. 4B). Two rigid surfaces (walls) 100, 104 may be separated by a characteristic gap (h) in a non-limiting range of 100 nm-10 mm.

Optionally, one or each of the walls may have surfaces made of polymers such as, without being limited thereto, polydimethylsiloxane (PDMS), polymethyl methacrylate (PMMA), cyclic olefin copolymer (COC), or inorganic materials such as glass. Optionally, at least one wall comprises (e.g., 95% or more, excluding regions patterned with variable surface charge) a material having an electrical conductivity low conductivity. For example the material is devoid of silicone. Optionally, by “low conductivity” it is meant to refer to: less than 1 S/m, less than 5 pS/m, 1 pS/m, or less than 0.1 pS/m, less than 1 nS/m, or less than 0.1 nS/m.

In some embodiments, the low conductivity characteristic of the wall allows to minimize or eliminate any interruption to the variable surface charge, or to the potential distribution provided by the electrode array or by the regions patterned with the variable surface charge.

Optionally, by “made of” it is meant to refer to at least 70%, 80%, 90%, 95%, 99%, or at least 99%, by weight, including any value or range therebetween.

Optionally, two walls 100, 104, are flat. Optionally, two walls 100, 104 are undulated. Optionally, one or two walls present structures, such as, without being limited thereto, posts, cavities, or any other macro and microstructures that can be produced by techniques known in the art.

Optionally, one or two walls have surfaces containing holes that may provide access to the container (e.g., chamber or microfluidic chamber).

FIG. 4C presents a schematic cross section of the lateral edge of the exemplary device in a non-limiting exemplary configuration, depicting that optionally gap h may be formed by a gasket layer 106, allowing the sealing of the microfluidic chamber and defining its lateral walls. Optionally, a conductive liquid 103 may fill the chamber formed by two surfaces 100, 104. Two reservoirs 107, 108 may ensure the fluidic access to the chamber and contain the electrodes 101, 102 for the EOF actuation.

In an alternative non-limiting embodiment (FIG. 3D), the top surface 104 may be hold by an external mechanical support 109 to a distance h from the bottom surface. Liquid 103 may be kept inside the chamber by capillary forces of liquid 103 in reservoir 107. Optionally, the cross section area of the container (e.g., microfluidic chamber) may vary in one or two dimensions. Optionally, the sealing is ensured by clamping the two surfaces by mechanical, magnetic forces or any other form of clamping known to those skilled in the art. Optionally, the gap is formed by holding the surfaces at the desired distance by external holders 109.

Optionally, one or both driving electrodes 101, 102 are typically made of a noble metal such as Pt, Au or other conductive material known to those skilled in the art, which may be in contact with the liquid inside the container and externally connected to an electrical power source.

Optionally, one or both driving electrodes may contact the liquid from holes (also referred to as “reservoirs”) through the surfaces.

Optionally, one or both driving electrodes are patterned on the surface through physical evaporation, sputtering or any other technique known to those skilled in the art. Optionally, the electrodes impose a DC electric field. Optionally, the two electrodes impose an AC electric field.

Optionally, a pressure gradient or a net fluid flow may be imposed on the microfluidic chamber by external controllers. Optionally, the external controllers are pressure regulator. Optionally, the external controllers are flow controllers, such as syringe pumps.

Optionally, the surfaces present regions patterned with variable surface charge (105a, 105b)). Optionally, the percentage of the regions patterned with variable surface charge is in the range 0%-100% (e.g., 1%, 10%, 20%, 30%, 40%, 50%, 60%, 70%, 80%, 90%, or 100%, including any value and range therebetween) of the total surface in contact with the liquid. In some embodiments, the surface charge pattern is invariant with time. Optionally, the surface charge is dynamically controlled and modified in time. Optionally, only one surface has regions patterned with variable surface charge. Optionally, both surfaces have regions patterned with variable surface charge. Optionally, the surface charge slowly varies in space within a patterned region. Optionally, the variable surface charge is patterned in circular regions. Optionally, the variable surface charge is patterned in rectangular regions.

Optionally, the variable surface charge is patterned in triangular regions. Optionally, the variable surface charge is patterned in triangular regions. Optionally, the variable surface charge is patterned in arbitrary geometrical regions.

Optionally, the variable surface charge may be generated by, without being limited to, chemical modification, active electrostatic modification, photochemical modification and any other method known to those skilled in the art.

Materials creating the desired chemical modification in the regions, providing the local charges may include, without being limited to: cross linked organic polymer including an epoxy-based homopolymer or copolymer; a surface modified organic homopolymer or copolymer; a self-assembled monolayer, a polymer brush-modified layer, or a cross-linked organosilicate; random copolymer brushes, random cross-linked copolymers, amino acids, proteins, nucleic acids, or mixtures of polymer brushes or cross-linked polymers, block copolymers, block termopolymers, homopolymers, DNA, and blends of these polymers; properly and precisely oxidized silicon surface; ceramics and oxides; metals and conductive materials. Examples of homo and copolymer include, but are not limited to, Poly(allylamine hydrochloride) (PAH), Poly(styrene sulphonate) (PSS), poly(diallyldimethylammonium chloride) (PDDA), branched poly(ethylenimine) (PEI), poly(ethylene glycol) (PEG), poly-L-lysine (PLL), photo-resists, and other molecules known to those skilled in the art. In some embodiments, the chemicals are covalently bonded to the surface. In some embodiments, the chemicals are patterned or adsorbed onto the surface. In some embodiments, the chemical modification is obtained by removing a chemical from a surface entirely coated with the chemical.

The term “chemical patterning” refers to the creation of a geometric or topological pattern of chemical entities or groups on a surface, or in a three-dimensional material.

In some embodiments, creation of a geometric or topological pattern refers to pattern configuration, on at least a portion of the surface.

In some embodiments, the chemically patterned layer is a self-assembled material.

In some embodiments, the oriented chemically patterned layer is a monolayer.

In some embodiments, the chemically patterned layer comprises pre-coated surface.

Optionally, the chemical modification is generated by depositing chemicals by a process including, not limited to, patterning using the microfluidic probe (MFP) technology, contact printing, non-contact printing, ink-jet technology, chemical vapor deposition (CVD), plasma enhanced CVD, atomic layer deposition (ALD), sputtering, silanization, thermal evaporation, electron beam evaporation, pulsed laser deposition, spin coating or other method known to those skilled in the art.

In some embodiments, “active electrostatic modification” refers to imposing a voltage on one or more conductive layer patterned on the surface. The patterned conductive layers (which may be externally controlled) are further referred to herein as “gate electrode”.

In another non-limiting configuration, the apparatus further comprises the gate electrode in direct contact with the liquid. Optionally, the gate electrode is covered with one or more thin layers of dielectric material, wherein the dielectric layer is as described hereinabove. In some embodiments, the dielectric layers is thick enough to ensure electrical insulation between the gate electrodes and the liquid. Optionally, the one or two surfaces have an array of gate electrodes. The shape of the gate electrodes as well as their distribution through the microfluidic chamber may vary depending on the desired EOF pattern. The voltage distribution among the gate electrodes may vary depending on the desired EOF pattern.

Optionally, variable surface charge refers to regions patterned by photochemical method, permitting the covalent attachment of active functional group onto solid surface. Optionally, photochemical process may be induced by a defined wavelength or a laser. Optionally, variable surface charge refers to region patterned with light-induced removal of molecules. Optionally, the intensity and exposure time of the light source on the surface can dynamically tune the surface charge.

Optionally, the conductive liquid is a Newtonian liquid (fluid). As used herein and in the art, Newtonian liquid is a fluid in which the viscous stresses arising from its flow, at every point, are linearly proportional to the local strain rate—the rate of change of its deformation over time. In some embodiments, the conductive liquid is a non-Newtonian liquid (fluid). In some embodiments, the conductive liquid comprises both a Newtonian fluid and a non-Newtonian fluid. In some embodiments, the conductive liquid comprises electrolytes.

In some embodiments, the conductive liquid comprises a buffer characterized by a pH value from 1 to 8, from 2 to 8, from 3 to 8, from 3 to 7, from 3 to 4, from 5 to 7, from 5 to 8, from 3 to 4.5, from 4.5 to 7.5, from 4 to 7, from 5 to 7.5, from 6 to 7.5, from 6 to 8 including any range or value therebetween.

In some embodiments, the pH of the conductive liquid is so that the outer surface of the dielectric layer is substantially charge neutral. In some embodiments, the pH of the conductive liquid is so that at least 60%, at least 65%, at least 70%, at least 75%, at least 80%, at least 85%, at least 90%, at least 92%, at least 95%, at least 98% of the outer surface of the dielectric layer is charge neutral.

In some embodiments, the buffer has an ionic strength of less than 500 mM, less than 200 mM, less than 100 mM, less than 80 mM, less than 60 mM, less than 50 mM, less than 40 mM, less than 30 mM, less than 20 mM, less than 15 mM, including any range or value therebetween.

In some embodiments, the buffer has an ionic strength in a range from 100 nM to 500 mM, from 100 nM to 500 nM, from 500 nM to 1 uM, from 1 uM to 100 uM, from 100 uM to 500 uM, from 500 uM to 700 uM, from 700 uM to 1 mM, including any range or value therebetween.

In some embodiments, the buffer has an ionic strength in a range from 10 uM to 500 mM, from 10 uM to 100 uM, from 100 uM to 200 uM, from 200 uM to 500 uM, from 500 uM to 700 mM, from 700 uM to 1 mM, from 1 mM to 10 mM, from 1 mM to 10 mM, from 10 mM to 20 mM, from 20 mM to 30 mM, from 30 mM to 40 mM, from 40 mM to 50 mM, from 50 mM to 70 mM, from 70 mM to 100 mM, from 100 mM to 150 mM, from 150 mM to 200 mM, from 200 mM to 250 mM, from 250 mM to 300 mM, from 300 mM to 400 mM, from 400 mM to 500 mM, from 1 mM to 200 mM, from 10 mM to 200 mM, from 50 mM to 100 mM, from 50 mM to 200 mM, from 50 mM to 500 mM, including any range or value therebetween.

In some embodiments, the buffer comprises an acid and a conjugate base thereof. In some embodiments, the buffer comprises a base and a conjugate acid thereof. Non-limiting examples of acids comprise but are not limited to: acetic acid, lactic acid, 2-(N-morpholino)ethanesulfonic acid (MES), citric acid, 4-(2-hydroxyethyl)-1-piperazineethanesulfonic acid (HEPES) or a combination thereof

Non-limiting examples of buffers comprise but are not limited to: acetic acid/NaOH, lactic acid/NaOH, bistris/HCL, phosphate buffered solution (PBS), citric acid/NaOH, MES/NaOH, HEPES/NaOH or any combination thereof.

In another non-limiting configuration, the apparatus comprises: a first layer and a second layer deposited in distance defining a chamber (e.g., microfluidic chamber), wherein the chamber is configured to contain a fluid comprising an electrolyte; a first and a second driving electrodes; a gate electrode deposited within a wall of the chamber, wherein the gate electrode is configured to provide or to carry a distinct surface local electrical field foci (e.g., a charge, or a zeta potential) a surface of the wall. Optionally, the dielectric layer in contact with the gate electrode is characterized by a similar breakdown voltage in response to a negative and to a positive voltage applied thereto.

In some embodiments, the dielectric layer is characterized by a breakdown voltage in a range from 0.01 to 2 V/nm, from 0.01 to 0.05 V/nm, from 0.05 to 0.1 V/nm, from 0.1 to 2 V/nm, from 0.1 to 0.5 V/nm, from 0.5 to 1.5 V/nm, from 0.5 to 1 V/nm, from 0.8 to 2 V/nm, from 0.8 to 1.5 V/nm, from 0.9 to 2 V/nm, from 0.9 to 1.5 V/nm, from 0.8 to 1.3 V/nm, including any range or value therebetween.

Optionally, the first and the second driving electrodes, may contact the fluid and further connect to a potential source. Optionally, the first and the second driving electrodes are as described hereinabove. Optionally, one or more walls of the chamber comprise a first wall and a second wall which are substantially parallel to each other. In some embodiments, a first wall and a second wall are as described hereinabove.

Optionally, the surface comprises a plurality of electric charges or surface charges (105a, 105b). Optionally, the surface presents regions comprising variable electric charge. Optionally, the percentage of the regions comprising variable surface charge is in the range 0%-100% (e.g., 1%, 10%, 20%, 30%, 40%, 50%, 60%, 70%, 80%, 90%, or 100%, including any value and range therebetween) of the total surface in contact with the liquid. In some embodiments, the surface charge pattern is invariant with time. Optionally, the surface charge is dynamically controlled and modified in time. Optionally, the surface charge or is adjustable or controllable by varying the potential of the gate electrode. Optionally, the electric charge is adjustable or controllable by varying the voltage applied to the gate electrode. An exemplary configuration of the gate electrode is represented by FIGS. 3A-B. Optionally, the electric charge is adjustable or controllable so as to result in a negative or a positive surface charge. Optionally, each surface charge is adjustable or controllable by varying the potential of the electrode (e.g. the gate electrode).

Optionally, the surface charge is characterized by a pattern. Optionally, the surface charge is characterized by a pattern of the gate electrode. Optionally, the surface charge is generated by one or more gate electrodes arranged in a pattern. Optionally, one or more gate electrodes are arranged so as to form a circular pattern. Optionally, the pattern of one or more gate electrodes is any geometric form (such as a circle, a circle within a circle, a semicircle, a triangle, a square, or any combination thereof). In some embodiments, the surface charge can be inverted (e.g. form a negative to a positive charge) by inverting the potential of the gate electrode. Exemplary patterns of the gate electrode are represented in the Examples section.

In some embodiments, the gate electrode is referred to as a patterned conductive layer (which may be externally controlled).

Optionally, the gate electrode is in direct contact with the liquid. Optionally, the gate electrode is covered with one or more thin layers of dielectric material. Optionally, the dielectric material is as described hereinabove.

Optionally, the conductive liquid is a Newtonian liquid (fluid). In some embodiments, the conductive liquid is as described hereinabove.

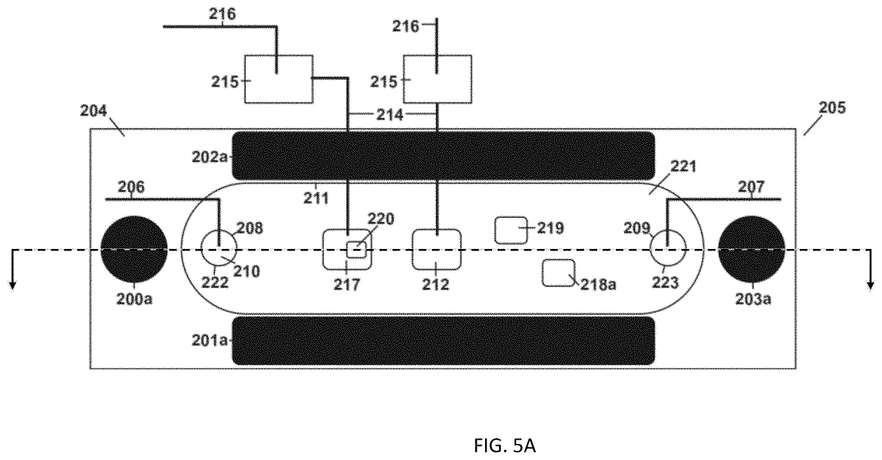

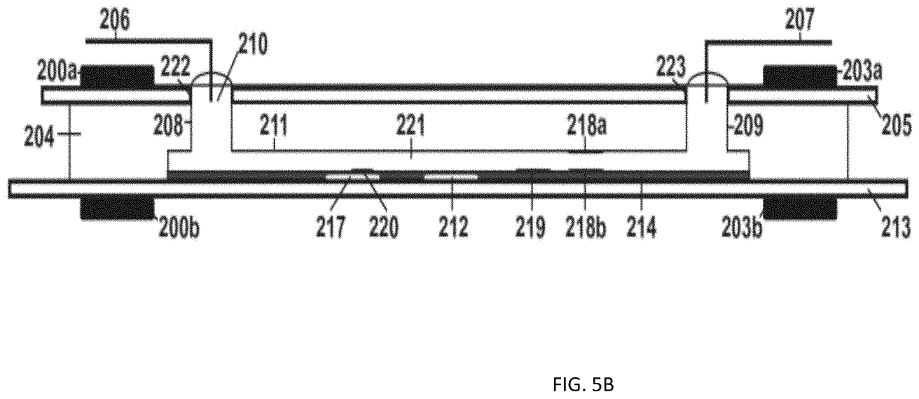

A further non-limiting exemplary configuration of the device is shown in the scheme presented in FIGS. 5A-B, showing a schematic top view of the exemplary device (FIG. 5A) and a schematic view of a cross section of the exemplary device (FIG. 5B). The device may have a gasket layer 204 made of polydimethylsiloxane (PDMS), in which a microfluidic chamber 221 may be fabricated using soft lithography. In this embodiment, the top surface 211 may be PDMS surface of the molded microfluidic chamber.

Two reservoirs 208, 209 may be punched through the full thickness of the PDMS, to provide external access to the microfluidic chamber 221. A rigid slide 205 may be bonded to the top side of the PDMS via plasma treatment to ensure rigidity to the PDMS, thus allowing to prevent the sealing from touching the microfluidic chamber floor. Two holes 222, 223 may be drilled through the full thickness of the rigid slide, allowing to provide access to the reservoirs punched in the PDMS. The bottom surface may be made by a rigid slide (e.g., made of glass) 213 which may be larger than the gasket layer.

Optionally, the PDMS may be in direct contact with the bottom slide and the sealing may be ensured by magnetic clamping. Optionally, in a non-limiting configuration four permanent magnets 200a, 201a, 202a, 203a may be placed in contact with the top slide magnetically attract other four permanent magnets on the bottom (200b, 201b, 202b, 203b) compressing the PDMS on the bottom slide. In an alternative optional configuration, the number, shape and spatial distribution of the magnates may vary. In an alternative optional configuration, mechanical clamping or any other clamping mechanism known to those skilled in the art may ensure the adequate sealing.

In an alternative optional configuration, the sealing may be obtained by placing the PDMS in contact with the bottom slide without any form of clamping.

Optionally, the bottom slide (or wall) 213 may be patterned with gate electrodes 212, 217 which may be in electrical communication with two external pads 215 via two connection threads 215. Gate electrodes, connection threads and external pads may be made of a layer of Ti with thickness in the range of 0.1-10 nm, covered by a layer of Pt with thickness in the range of, for example and without limitation, 1 to 100 nm.

In an alternative optional embodiment, gate electrodes, connection threads and external pads may be made of other conductive materials known to those skilled in the art. The gate electrodes 217, 212 may be covered with a thin dielectric layer with thickness in the range of, for example and without limitation, 1 nm to 10 μm. Optionally, the external pads are not covered with any dielectric and are connected to an external electrical circuit through two controlling (driving) electrodes (216). In alternative optional embodiments, the dielectric layer is absent and the gate electrodes are in direct contact with the liquid.

Optionally, on top of the dielectric layer and on the top surface of the microfluidic chamber, regions with chemical modification (218a, 218b, 219, 220) may be patterned with various shapes and locations.

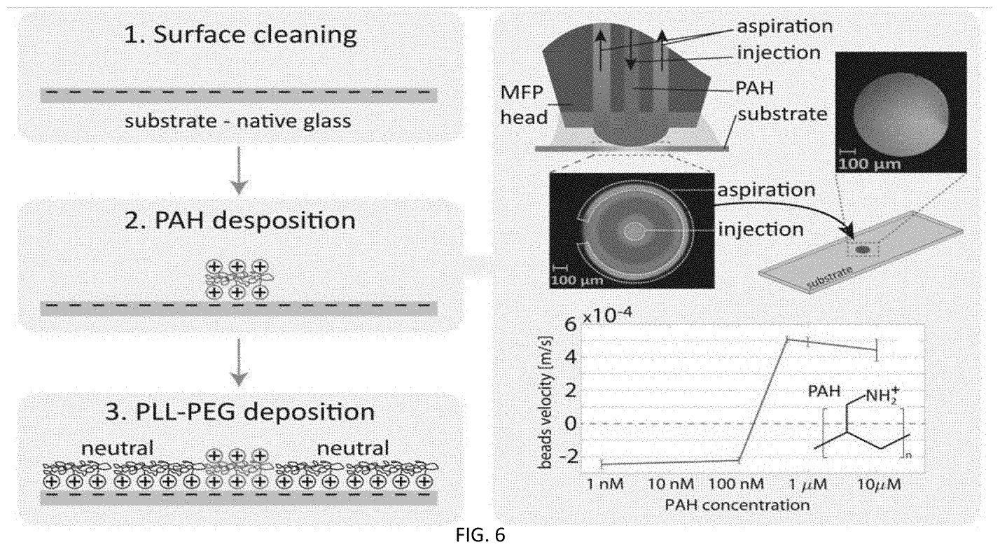

As an example, FIG. 6 presents the creation of a 600 μm diameter disk using the microfluidic probe (MFP) technology having positive surface charge, on top of a negatively charged glass slide. The established depth-averaged flow field takes the form of a dipole in uniform flow, resulting in streamlines which curve around the disk.

Optionally, the two surfaces may be coated with a chemical giving a nearly zero surface charge, e.g. polyethylene glycols (PEG) and its derivatives or other molecules known to those skilled in the art. Optionally, the spot may be negatively charged, e.g., coated with Poly(styrene sulphonate) (PSS) or other molecules known to those skilled in the art. Optionally, the EOF pattern is given by the superposition of the EOF patterns of two or more spots. In some embodiments, the chemical pattern may be a spatial surface gradient of one or more molecules. Optionally, the chemical patterns may comprise by two or more spots using the same molecules with different surface concentration.

Optionally, the EOF patterning is used to precisely control the fluid transport in the microfluidic chamber. Optionally, the fluid transport is used to deliver chemicals and/or biochemical to specific regions. Optionally, the delivery of chemicals and/or biochemical to specific regions is used to control and/or enhance chemical and/or biochemical reactions. Optionally, heat micro-source and heat micro-sink are placed in contact with the microfluidic chamber generating a heat distribution. Optionally, the fluid transport may be used to control the heat distribution.

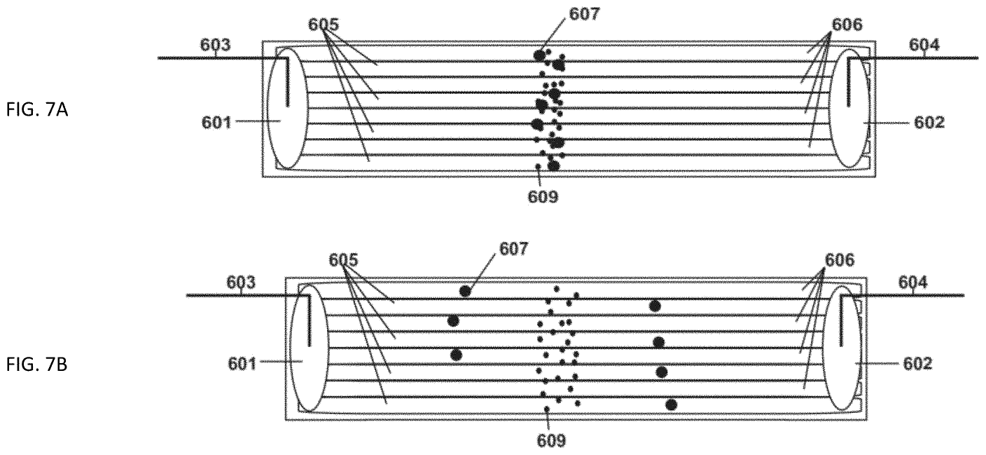

A non-limiting exemplary embodiment of the disclosure is described for diffusivity-based separation of particles and molecules is shown in FIGS. 7A-B. Optionally, the top and bottom surfaces of the chamber (e.g., microfluidic chamber) may be patterned with stripes (605, 606) of opposite surface charges. Optionally, the two reservoirs (601,602) are connected with an external power source through the electrodes (603,604).

In a non-limiting exemplary procedures, at time t0 (FIG. 7A), particles (such as neutral particles and/or charged particles) with different diffusivity are placed in a central region of the microfluidic chamber. Without being bound by any particular theory, larger particles (607) have a lower diffusivity than smaller particles (609). In some embodiments, particles with greater molecular weight have a lower diffusivity than particles with lower molecular weight. At time t1 (FIG. 7B), a voltage may be applied between the two reservoirs (e.g. to the first and the second driving electrodes) and the EOF is established in the microfluidic chamber. In some embodiments, is substantially linear EOF is established in the microfluidic chamber. In some embodiments, the pattern of the EOF is substantially linear. In some embodiments, the EOF comprises regions with parallel flow pattern, wherein each region is characterized by an opposite flow direction. The direction of the EOF may opposite over region with opposite surface charge. Particles with low diffusivity may move mainly under the effect of the EOF and therefore may constantly move in only one direction. Particles with high diffusivity will move mainly under the effect of diffusion and sample regions with different surface charges; therefore, their direction may vary over time as they experience EOF in different direction. The overall motion of the particle with lower diffusivity towards the two reservoirs may be faster than the particle with higher diffusivity, causing their separation.

Optionally, the particles may have a distribution of different diffusivity. Optionally, the initial location of the particles is in the reservoirs.

Optionally, the system comprises a control unit. In some embodiment, the control unit comprises an electronic circuitry unit.

Optionally, the control unit may modulate a charge distribution on a surface of one of the walls of the container. In some embodiments, the control unit maintains a constant charge distribution on a surface. In some embodiments, the control unit regulates a potential of one or more gate electrodes. In some embodiments, the control unit maintains a substantially equal potential of one or more gate electrodes. In some embodiments, the control unit modulates a charge distribution on a surface of the chamber so as to establish a uniform EOF. In some embodiments, the control unit modulates an amplitude and/or frequency of any one of the gate electrodes, so as to establish a substantially equal surface charge along the chamber. In some embodiments, the control unit modulates an amplitude and/or frequency of any one of the gate electrodes, so as to establish a uniform EOF. In some embodiments, a uniform EOF comprises particles having substantially the same flow rate and/or flow direction. In some embodiments, a uniform EOF comprises a substantially linear flow pattern within at least a part of the chamber.

Optionally, the control unit may regulate the DC. In some embodiments, the control unit regulates at least one of voltage, current, frequency, and amplitude of the AC.

Optionally, the disclosed system further comprises a computer program product.

Optionally, the computer program product comprises a computer-readable storage medium. The computer-readable storage medium may have program code embodied therewith. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to drawings and/or diagrams of methods, apparatus (systems), and computer program products according to embodiments of the invention. It will be understood that each illustration and/or drawing, and combinations thereof, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the drawings. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the drawings.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the drawings.

In some embodiments, the program code is excusable by a hardware processor.

In some embodiments, the hardware processor is a part of the control unit.

In some embodiments, there is further provided a read-out of the assay carried out in the disclosed system or device may be detected or measured using any suitable detection or measuring means known in the art. The detection means may vary depending on the nature of the read-out of the assay. For example, for assays providing a fluorescent read-out, the detection means may include a source of fluorescent light at an appropriate wavelength to excite the fluorophores in the reaction sites and means detect the emitted fluorescent light at the appropriate wavelength. The excitation light may be filtered using a bandwidth filter before the light is collimated through a lens. The same (e.g., Fresnel) lens may be used for focusing the illumination and collection of the fluorescence light. Another lens may be used to focus the fluorescent light onto the detector surface (e.g., a photomultiplier-tube). Fluorescent read-outs may also be detected using a standard fluorescent microscope fitted with a CCD camera and software. In some embodiments, disclosed system also relates to an apparatus including the device in any embodiments thereof, and a detection means as described herein.

### The Method

According to another aspect, there is provided a method of establishing an electroosmotic flow of an electrolyte or a charged particle in a fluid (e.g., a liquid), comprising the steps of:

(i) depositing the fluid in a container comprising a first driving electrode and a second driving electrode arranged on opposite ends of the container;
(ii) providing a plurality of surface charges, located within or adjacent to the fluid volume, wherein a charge of each of the surface charge is independently controlled.
(iii) generating a voltage across a fluid volume in the container via the first driving electrode and the second driving electrode so as to provide an electric field within the liquid; thereby establishing a controlled flow pattern of the electrolyte or particle.

In some embodiments the disclosed method may by applied for one or more from, without being limited thereto: (i) separation small molecules and particles based on their diffusivity and mobility, (ii) performing single cell or population cell communication, (iii) delivering chemicals for biochemical reactions control; and (iv) sample analysis.

Optionally, the electroosmotic flow is characterized by a flow pattern. Optionally, the electroosmotic flow is controllable by modifying one or more surface charges. In some embodiments, the flow pattern is controllable by modifying one or more surface charges. In some embodiments, the electroosmotic flow is a laminar flow. In some embodiments, the electroosmotic flow is unidirectional flow. In some embodiments, the electroosmotic flow is a non-unidirectional flow. In some embodiments, the flow pattern is predetermined by the pattern of one or more gate electrodes, as described hereinabove. In some embodiments, the flow pattern is controllable by modifying the voltage of one or more gate electrodes. In some embodiments, the flow pattern is controllable by modifying the potential of one or more gate electrodes. In some embodiments, the flow pattern is controllable by modifying the charge on the surface (such as a positive, a negative charge or a zero surface charge).

In some embodiments, the flow pattern comprises any geometric form, wherein the geometric form is as described for gate electrodes. In some embodiments, the flow pattern is a linear flow pattern. In some embodiments, the flow pattern is a circular flow pattern. In some embodiments, the flow pattern comprises regions with flow velocity of about 0. In some embodiments, the flow pattern comprises regions of flow and regions of stagnation. In some embodiments, the gate electrode generates one or more flow patterns. Exemplary flow patterns are represented in the Examples section.

In some embodiments, the fluid comprises a sample.

Unless otherwise indicated, as used herein, a “sample” refers to a fluid (e.g., gas or liquid) capable of flowing through a channel and containing an electrolyte or charged particles as described herein. Thus, a sample may include a fluid suspension of biologically derived particles (such as cells) as further described herein. In some embodiments, the fluid is as described hereinabove.

The sample may comprise a material in the form of a fluid suspension that can be driven through container or microfluidic channels can be used in the systems and methods described herein. For example, a sample can be obtained from an animal, water source, food, soil, or air. If a solid sample is obtained, such as a tissue sample or soil sample, the solid sample can be liquefied or solubilized prior to subsequent introduction into the system. If a gas sample is obtained, it may be liquefied or solubilized as well. The sample may also include a charged liquid or gas as the particle. For example, the sample may comprise bubbles of oil or other kinds of liquids or gases as the charged particles suspended in an aqueous solution.

A sample can generally include suspensions, liquids, and/or fluids having at least one type of particle, cellular, droplet, or otherwise, disposed therein. Further, focusing can produce a flux of particles enriched in a first particle based on size.

The term “biological sample” as used herein refers to a sample that may originate, be obtained or isolated from any source of the animal kingdom, depending on the intended use of the method of the invention. For example, the sample may originate, be obtained or isolated from any subject of vertebrates, such as mammals, reptiles, fish, birds, and amphibians. In some embodiments, the biological sample is isolated or originating or obtained from a mammalian subject, such as a human being or a bovine subject. In other non-limiting examples, the sample is a sample originating, obtained or isolated from a ruminant, a ferret, a badger, a rodent, an elephant, a bird, a pig, a deer, a coyote, a camel, a puma, a fish, a dog, a cat, a non-human primate or a human.

In some embodiments, the biological sample is selected from a biological content selected from a single cell, a population of cells, urine sample, sputum sample, cerebrospinal fluid, cell extract, tissue sample, blood sample, viruses, virus particles, organelles, protein(s), nucleotide(s) (e.g., DNA, RNA) or metabolites.

In some embodiments, the protein is selected from a growth factor, cytokine, chemokine, neurotransmitter, antibody or an enzyme.

In some embodiments, the term “isolated” refers to isolated from the natural environment. In some embodiments, the term relates to blood or tissue sample isolated from a subject to be diagnosed.

Exemplary biological samples can include, but are not limited to, cells, alive or fixed, such as adult red blood cells, fetal red blood cells, trophoblasts, fetal fibroblasts, white blood cells, epithelial cells, tumor cells, cancer cells, hematopoeitic stem cells, bacterial cells, mammalian cells, plant cells, neutrophils, T lymphocytes, B lymphocytes, monocytes, eosinophils, natural killer cells, basophils, dendritic cells, circulating endothelial cells, antigen specific T-cells, and fungal cells.

In some embodiments, the biological sample is a blood sample, a tissue sample, a secretion sample, semen, ovum, hairs, nails, tears, urine, biopsy or feces. A common sample type is a blood sample. The blood sample may include any fraction of blood, such as blood plasma or blood serum, sputum, urine, cell smear.

In some embodiments, the biological sample is obtained from any source of human or animal consumption, such as food or feed; i.e. the sample is a food or feed sample. In some embodiments, the sample is water, such as, without limitation, drinking water and domestic water.

The terms “biological assay” or “bioassay” as used herein interchangeably may refer to any assay involving a biological sample. Bioassays are performed in order to determine the presence or concentration or any other desired attributes of a biological molecule or a cell or cell population or an organism. Non-limiting example of bioassays that can be performed using the disclosed system or method are: enzymatic assay, a binding assay, immunoassay, nucleic acid hybridization, PCR, electrophoresis, liquid chromatography, cell activation, cell migration, cell separation, cell quantification, proteomic analysis, genomic analysis, DNA sequencing, microorganism detection, viral detection, DNA/RNA microarray, antibody array.

The sample may be diluted or concentrated prior to application to the device or it may be subject to pre-treatment steps to alter the composition, form or some other property of the sample. Pre-treatment steps may include, for example, cell lysis.

As used herein the term “immunoassay” refers to a biochemical test that measures the level of a substance in a biological liquid, such as serum or urine, using the reaction of an antibody and its antigen. The assay takes advantage of the specific binding of an antibody to its antigen. Monoclonal antibodies are often used as they only usually bind to one site of a particular molecule, and therefore provide a more specific and accurate test, which is less easily confused by the presence of other molecules. The antibodies picked must have a high affinity to the antigen (if there is antigen in the sample, a very high proportion of it must bind to the antibody so that even when only a few antigens are present, they can be detected). In an immunoassay, either the presence of antigen or the patient's own antibodies (which in some cases are indicative of a disease) may be measured. For instance, when detecting infection the presence an antibody against the pathogen is measured. For measuring hormones such as insulin, the insulin acts as the antigen. Typically, for numerical results, the response of the fluid being measured is compared to standards of a known concentration. The detection of the quantity of antibody or antigen present can be achieved by either the antigen or antibody. An antibody may be primary or secondary.

The term “primary antibody” as used herein, refers to a component of the immunoassay. Typically, the “primary” or “capture” antibody is positioned at a pre-determined location on a substrate and subsequently exposed to an array of antigens. Only the antigens associated with the capture antibody will combine irreversibly with the antibody. The terms “primary antibody” and “capture antibody” are used interchangeably in this description.

In some embodiments, the term “secondary antibody” refers to the signaling component of the immunoassay. The secondary antibody may be labeled with a fluorescent dye (in the case of fluorescent detection) or with an enzyme (for electrochemical or ELISA or chemiluminescent detection). The secondary antibody will selectively bind with the antigens (which are typically already bound to the primary antibody and thus fixed to the substrate), and is then subsequently interrogated using an appropriate technique.

In some embodiments, detection of the immuno complex is performed using fluorescence activated cell sorting (FACS), enzyme linked immunosorbent assay (ELISA), Western blot and radio-immunoassay (MA) analyses, immunoprecipitation (IP) with optionally the use of magnetic beads or by a molecular weight-based approach.

As described hereinthroughout, microfluidic systems, such as the disclosed device, may be partially made of PDMS because of its favorable mechanical properties, optical transparency, and bio-compatibility.

Microfluidic cell culture devices have been developed for diverse cell types such as Eukaryotic cells, lung cells, embryonic stem cells, and mammalian embryos.

Most microfluidic cell culture devices separate cell loading zones from designated cell culture zones. This separation requires additional external forces and elaborate works for the cell in the loading zone to be transported to the designated culture zone. Also, the transport processes can put stress on sensitive cells such as mammalian embryo or embryonic stem cells. In addition, once the cells reach the designated culture zone, additional design and fabrications are required for cell confinement to apply diverse culture conditions with flows.

As described hereinabove, the disclosed device may be used for the characterization of biomolecules. Some non-limiting examples of assays for the characterization of biomolecules are set forth.

In some embodiments, the assay e.g., biological assay, such as, without limitation, immunoassays and gene expression analysis, is carried out using microarray, such as nucleotide (DNA) microarray, protein microarray or antibody microarray, for example.

A microarray is a collection of microscopic spots such as DNA, proteins or antibodies, attached to a substrate surface, (such as a glass, plastic or silicon), and which thereby form a “microscopic” array. Such microarrays may be used to measure the expression levels of large numbers of genes or proteins simultaneously. Typically, but not exclusively, biomolecules, such as, without limitation, DNA, proteins or antibodies, on a microarray chip are detected through optical readout of fluorescent labels attached to a target molecule that is specifically attached or hybridized to a probe molecule. The labels used may comprise e.g., an enzyme, radioisotopes, or a fluorophore.

According to some embodiments, the herein disclosed devices or systems may be used so as to conduct high throughput separation and analysis.

The separation may be based on accurate flow controls through the container (e.g., in the form of microfluidic channels). By designing patterned fluidic channels, or channels with specific dimensions in the micro or sub-micro scales, often on a small chip, it is possible to carry out multiple assays simultaneously. As further detailed herein, the cells and biomolecules in microfluidic assays may be detected by optical readout of fluorescent labels attached to a target cell or molecule that is specifically attached or hybridized to a probe molecule.

In some embodiments, the disclosed device and methods are used for integrated nucleic acid (DNA, RNA, cDNA, etc.) extraction and fractionation of different molecular weight nucleic acid molecules, from biological and clinical samples for downstream applications such as, but not limited to, polymerase chain reaction (PCR), Helicase-dependent amplification (HDA), recombinase polymerase amplification (RPA), Hybridization (such as southern blotting, microarrays, expression arrays, etc.), DNA sequencing (including integrated extraction and size selection for paired-end sequencing) and other related applications.

A lab-on-a-chip device, as presented hereinthroughout, may be used e.g., for both extracting DNA and selecting for the DNA molecular weight.

In some embodiments, the disclosed device may be used as a biosensor. As defined herein and in the art, biosensors are analytical devices that combine a biological material (tissues, microorganisms, enzymes, antibodies, nucleic acids etc.) or a biologically-derived material with a physicochemical transducer or transducing microsystem. This transducer may be e.g., optical, electrochemical, thermometric, piezoelectric, magnetic or radioactive. Biosensors may yield a digital electronic signal which is proportional to the concentration of a specific analyte or group of analytes. While the signal may in principle be continuous, the disclosed devices may be configured to yield single measurements to meet specific application requirements. Biosensors may be used in a wide variety of analytical problems including those found in medicine, the environment, food processing industries, security and defense.

In some embodiments, the biological assay includes introduction of a biologically active agent to a sample. Non-limiting examples of biologically active agents are selected from drugs, such as, anticancer drug or combination of drugs, retinoic acid, monoclonal antibody, siRNA, RNA, microRNA, DNA, a plasmid a bisphosphonate, antibacterial and antifungecide reagent.

In some embodiments of the disclosed device, the surface of the channels and reaction chambers may be treated so as to prevent or to reduce adsorption on a surface thereof a material of sample constituents or a reaction product. Such surface treatment may comprise methods including but not limited to: flowing a sacrificial substance through the channel, thereby reducing loss of material, treating the surface with biological material such as bovine serum, polymerase enzymes or other such materials, or chemically treating the surface to prevent loss. Treatments may include, but are not limited to, the placement of materials that may create a hydrophilic or hydrophobic surface to allow a smoother flow. In some embodiments, fluorocarbons and similar materials (Teflon, as an example would act as a hydrophobic barrier, or polyacrylates) may be deposited on to the surface of the channels and/or reaction chambers. Other methodologies such as UV coatings and polymer brushes that are chemically grown off the surface may also be contemplated.

In some embodiments, any surface treatment known in the art may be applied to the membrane or to the surface of the microfluidic channels or chambers of the disclosed device e.g., to prevent enzymes from denaturing thereon. In some embodiments, this treatment may actually enhance the performance of the enzyme or allow further stability of the enzyme.

In some embodiments, the enzyme may be attached to a membrane of the device using chemical or biological linker. Such linkers may include but are not limited to di-sulfide linkers, bis-amine linkers, silane chemistries, peptide recognition moieties, histidine tagging linkers, ion recognition moieties as well as biological species that may show an affinity to the surface and/or the enzyme itself In some embodiments, the enzymes (e.g., polymerase) may bind to surface species or be coupled with enzymes with such properties.

In some embodiments, the enzymes may be placed in certain regions of the disclosed device e.g., to provide optimum conditions for a reaction to take place. In some embodiments, this placement may be carried out e.g., by enhancing the enzyme affinity to one or more desired areas within the device. In some embodiments, there is provided a kit comprising the disclosed device, in any embodiment thereof. In some embodiments, the kit may be used for certain medical uses including, without being limited thereto, diagnostics.

The term “diagnosis” and any grammatical derivative thereof, as use herein, refers to a method of determining a disease or disorder in a subject. In some embodiments, the term “diagnosis” refers to determining presence or absence of pathology, classifying pathology or a symptom or determining a severity of the pathology.

For example, the method may comprise identifying a microorganism or a biomarker in a sample from the subject wherein the presence of the microorganism in the sample is e.g., indicative of the disease or disorder.

The terms “diagnosis” may also refer to “prognosis” which may include monitoring the diagnosis and/or prognosis over time, and/or statistical modeling based thereupon. That is, in some embodiments, the diagnosis may include: a. prediction (e.g., determining if a patient will likely develop a hyperproliferative disease) b. prognosis (predicting whether a patient will likely have a better or worse outcome at a pre-selected time in the future) c. therapy selection.

In some embodiments, the term “prognosis” as used herein refers to forecasting an outcome of pathology and/or prospects of recovery including the efficacy of medication or treatment. In some embodiments, the term “prognosis” further refers to the determination of tumor progress.

The terms “marker”, or “biomarker”, refer to a biomolecule that is generated in response to a specific physiological condition. For example, muscular stress injuries cause the release of a biomarker called CRP whereas cardiovascular injuries cause the liberation of Cardiac Troponins. Biomarkers may or may not be uniquely associated with a particular physiological condition.

In some embodiments, the disclosed device is further used to assess the change in status of the expression of a biomarker. The term “status” in this context is used according to its art accepted meaning and refers to the condition or state of a gene and/or its products including mRNA and protein. Typically, skilled artisans use a number of parameters to evaluate the condition or state of a gene and its products. These include, in some embodiments, but are not limited to, the location of expressed gene products (including the location of the marker expressing cells) as well as the level, and biological activity of expressed gene products (such as mRNA and polypeptides). In some embodiments, an alteration in the status of biomarker exhibits a change in the location of the mRNA or protein and/or the cell marker and/or an increase in the cell marker mRNA and/or protein expression, or any combination thereof.

As a non-limiting example, the method and device described herein may be used for screening or diagnosing a disease, e.g., cancer. In some embodiments, a cancer cell marker probe is a labeled antibody which specifically recognizes a cancer cell marker. In some embodiments, a cancer cell marker probe is a primary antibody which specifically recognizes a cancer cell marker and a secondary antibody comprising a label. In some embodiments, a cancer cell marker probe is a labeled nucleic acid molecule which specifically recognizes a cancer cell marker. In some embodiments, a cancer cell marker probe is a labeled protein which specifically recognizes a cancer cell marker. In another embodiment, a cancer cell marker probe is a labeled small molecule which specifically recognizes a cancer cell marker.

In some embodiments, determining a level of a protein is performed by quantifying the amount of the protein in a sample by an indirect method such as, but not limited to, ELISA. In some embodiments, determining a level of a protein is performed by immunohistochemical analysis on a target tissue and quantifying the intensity and/or number of cells labeled. In some embodiments, any method known in the art for detecting and directly/indirectly quantifying a protein within cells or a tissue, may be applied. In some embodiments, a predetermined reference value is obtained by measuring the level of a protein (or proteins) in a parallel healthy tissue or cells. In some embodiments, a predetermined reference value is obtained by measuring the level of a protein (or proteins) in a parallel non-malignant tissue or cells. In some embodiments, a predetermined reference value is obtained by measuring the level of a protein (or proteins) in a parallel inflamed tissue.

As used herein, the term “level” refers to the degree of gene expression and/or gene product expression or activity in the biological sample. Accordingly, the level of a protein of the invention serving as a marker is determined, in some embodiments, at the amino acid level using protein detection methods.

In some embodiments, the device or kit disclosed herein is used for drug discovery.

By “drug discovery” it is meant to refer to measuring drug activity, and/or for evaluating the effect of a candidate drug on a cell, cell type or microorganism.

Herein, “sample analysis” may be a single cell analysis and/or chemical analysis on small volume such as micro-sized volume. In some embodiments, the analysis is chemical analysis. The term chemical analysis can refer to, for example, the qualitative and/or quantitative detection and/or separation of molecules of interest. In some embodiments, the device and method disclosed herein enables processing large volumes of samples (e.g., hundreds of μL) in short period of time (relative to the time required using other alternatives such as low current).

In some embodiments, the method further comprises a step of labeling the samples e.g., using a labeling agent. As used herein, the phrase “labeling agent” or “labeling compound” describes a detectable moiety or a probe. Exemplary labeling agents which are suitable for use in the context of these embodiments include, but are not limited to, a fluorescent agent, a radioactive agent, a near IR dye (e.g., indocyamine green), a rhodamine dye, a fluorescein dye, a magnetic agent or nanoparticle, a chromophore, a photochromic compound, a bioluminescent agent, a chemiluminescent agent, a phosphorescent agent and a heavy metal cluster.

In some embodiments, the label is a dye. In some embodiments, the label is a fluorescent dye. In other embodiments, the label is a radioactive agent. In some embodiments, the label is a metal such as but not limited to gold or silver.

The phrase “radioactive agent” describes a substance (i.e. radionuclide or radioisotope) which loses energy (decaysy emitting ionizing particles and radiation. When the substance decays, its presence can be determined by detecting the radiation emitted by it. For these purposes, a particularly useful type of radioactive decay is positron emission. Exemplary radioactive agents include ^{99m}Tc ¹⁸F, ¹³C and ¹²⁵I.

As used herein, the term “chromophore” describes a chemical moiety that, when attached to another molecule, renders the latter colored and thus visible when various spectrophotometric measurements are applied.

The term “bioluminescent agent” describes a substance which emits light by a biochemical process.

The term “chemiluminescent agent” describes a substance which emits light as the result of a chemical reaction.

The phrase “fluorescent agent” refers to a compound that emits light at a specific wavelength during exposure to radiation from an external source.

The term “fluorescent detection” refers to a process wherein, excitation is supplied in the form of optical energy to a particular molecule which will then absorb the energy and subsequently release the energy at another wavelength. The fluorescent detection technique requires the use of an excitation source, excitation filter, detection filter and detector.

The term “chemiluminescence” refers to a process wherein certain molecules when catalyzed in the presence of an enzyme, undergo a specific biochemical reaction and emit light at a particular wavelength as a result of this reaction. Chemiluminescent detection techniques only require a detector without the need for an excitation source or filters.

The phrase “phosphorescent agent” refers to a compound emitting light without appreciable heat or external excitation.

Cell detection may be achieved, for example, by flow cytometry techniques using transparent microfluidic devices and suitable detectors. Embedding optical fibers at various angles to the channel can facilitate detection and activation of the appropriate activators. Similar detection techniques, coupled with the use of valves to vary the delivery from a channel to respective different collection sites or reservoirs may be used to sort embryos and microorganisms, including bacteria, fungi, algae, yeast, viruses, sperm cells, etc.

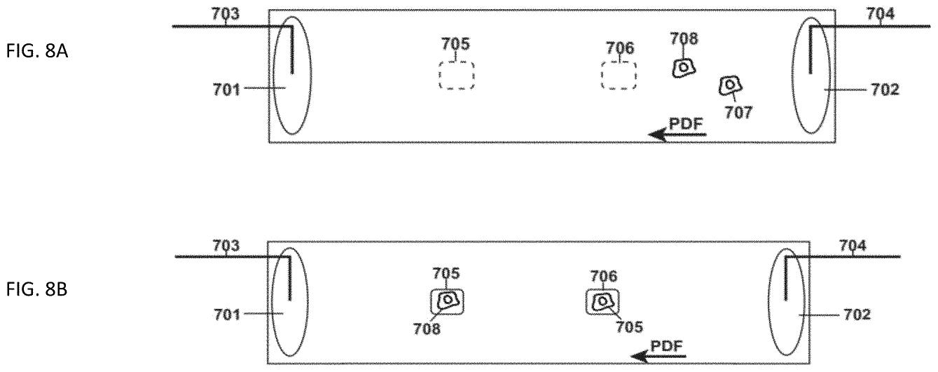

In additional non-limiting exemplary embodiments the disclosed system is used for two cell communication as depicted in FIG. 8A-B. In exemplary configuration, the top and bottom surfaces of the microfluidic chamber may be patterned with two spots (also referred to as “layers”) (705, 706) of variable surface charge. The two reservoirs (701, 702) may be connected with an external power source through the electrodes (703, 704) and to a flow control system.

In a non-limiting exemplary procedures, at time t0 (FIG. 8A), two cells (707, 708) are introduced in the microfluidic chamber and carried by a pressure driven flow (PDF) imposed by the external flow controller which is dominant with respect of the EOF. At time t1 (FIG. 8B), when the cells reach the two spots (local charge) (705, 706) the surface charge is modified on these spots such us EOF opposes the PDF. Therefore, the zero flow velocity on the spots keep the cells ‘virtually’ confined one from the other, whereas chemicals and/or nutrients can be delivered to the cells or from one cell to the other.

As noted hereinabove, the device of the present invention may be used for the study and characterization of cellular networks or cell-cell interactions. Cell-cell interactions play a key role in the development and activities of multicellular organisms. Stable cell-cell interactions maintain the integrity and functions of cells in tissues. More transient cell-cell interactions through multivalent ligand-receptor interaction on the cell surface underlie many aspects of immune responses, including target recognition, immune cell activation and target elimination. For example, cells of the immune systems detect foreign antigens presented on the surface of infected cells, or identify and eliminate cancer cells that exhibit aberrant cell surface proteins.

In some embodiments, the cell-cell interaction may be detected and verified by any suitable methods known in the art. For example, cell-cell interaction can result in cell aggregation. Aggregated cells may be detected based on size differential as revealed by density gradient or flow cytometry. Different types of cells can be first labeled with specific fluorescent dyes and the cell aggregates can be detected by flow cytometry. Cell-cell interaction may also be directly examined and verified by fluorescence microscopy. All the embodiments of this aspect may be applied in conjunction with any embodiments of the invention described herein.

In some embodiments, the device is configured to form reaction chambers and microchannels and may be reshaped dynamically so as to generate, e.g., complex experimental design in which cells are manipulated to be mixed and separated continuously where different liquids may be introduced and removed.

In some embodiments, the device may be used for cell crushing. Cells may be crushed by e.g., transporting them in channels through active portions and actuating channel closure to crush the cells flowing through the channels.

### General

As used herein the term “about” refers to ±10%.

The terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLES

Reference is now made to the following examples which, together with the above descriptions disclosed herewith, illustrate the invention in a non-limiting fashion.

### Example 1

### Exemplary Devices

In an exemplary device, for the purpose of microscale flow control, complex patterns were created, including ones containing isolated regions.

As illustrated in FIG. 5, first the substrate (a standard microscope glass slide) was cleaned by flushing it with acetone and ethanol for 1 min each, followed by 1 min of atmospheric plasma. Poly(allylamine hydrochloride) (PAH), a positively charged polymer, was deposited locally on the substrate by using the MFP, with a resident time of 5 min per spot. To visualize the resulting surface patterns, a PAH derivative that is labeled with FITC was used. The PAH was dissolved in a solution of 100 mM NaCl, 100 mM tris, 50 mM HCl (pH 8.2) to optimize its absorption onto glass by electrostatic interaction. The patterning was completed by rinsing the slide with DI and drying it with nitrogen gas. Separately, a 15 μm deep×1.5 mm wide microfluidic chamber in PDMS was created.

This chamber was cleaned with ethanol, and then was attached to the patterned glass to complete the fluidic chamber. To reduce the zeta potential of the unpatterned glass and PDMS surfaces, the closed chamber was flushed for 5 min with PLL-PEG, a poly(L-lysine) randomly grafted with poly(ethylene glycol) side-chains, in a solution of 10 mM hepes and 5 mM NaOH (pH 7.4). The PLL binds electrostatically to the silano groups on the glass and PDMS surfaces, while the PEG chains screen the electric double layer. Finally, the chamber was cleaned by flushing it with DI for 2 min.

The EOF experiments were performed in a solution of 5 mM bistris and 2.5 mM HCl (pH 6.4). To visualize the flow streamlines 1 μm diameter fluorescent carboxylic beads coated with PLL-PEG was used, having a zeta potential value of approximately −3 mV (as measured by Malvern Zeta Sizer), approximately an order of magnitude smaller than the zeta potential of the glass or PAH. An epifluorescene microscope was used to track the beads movement using an exposure time of 3 s and obtain the streamlines by superposing multiple frames.

To test the effect of PAH on the EOF velocity, a 3 cm long, 15 μm deep and 100 μm wide PDMS/glass microchannel was uniformly coated by flushing it with PAH concentrations ranging from 1 nM to 10 μM, for 5 minutes. The channel was then filled with a solution of 50 mM bistris, 25 mM HCl containing PLL-PEG coated carboxylic beads and applied an electric field of 166 V/cm, assigning positive velocities to beads moving toward the positive electrode. As shown in FIG. 6, the EOF exhibits a bi-modal behavior, with a PAH concentration between 100 nM and 500 nM being the transition point from a measured velocity of approximately −200 μm/s to ˜500 μm/s.

### Example 2

### Results

The steady creeping flow within a narrow gap was considered between two parallel plates subjected to a uniform in-plane electric field. FIG. 9 presents a schematic illustration of the configuration and the Cartesian coordinate system, whose x andy axes lie at the lower plane and is perpendicular thereto. The lower and upper plates have an arbitrary zeta potential distribution, respectively, defined as ζ_{L}(x,y) and ζ_{U}(x,y), which varies over a characteristic length scale l in the x-y plane.

Considering a thin electric double layer and assuming a low Reynolds number and shallow flow, characterizing of typical microfluidic configurations, the flow field in the bulk can be described by the lubrication equations

$${\vec{∇}}_{\vert \vert} p = η \frac{{\partial }^{2} {\vec{u}}_{\vert \vert}}{\partial {z}^{2}} , \frac{\partial p}{\partial z} = 0 , \vec{∇} \cdot \vec{u} = 0 , \qquad ( 1 )$$

where \vec{u}=(\vec{u}_{∥},u_{z}) is the velocity vector, p is the fluid pressure, η is the dynamic viscosity and \vec{∇}_{∥}=(∂/∂x, ∂/∂y) is a two-dimensional gradient. We account for the body forces acting on the double layer by using the Helmholtz-Smoluchowski slip boundary conditions^{4,5}

$${\vec{u}}_{\vert \vert} {\vert}_{z = 0} = - \frac{{ɛζ}_{L}}{η} {\vec{E}}_{\vert \vert} , {\vec{u}}_{\vert \vert} {\vert}_{z = h} = - \frac{{ɛζ}_{U}}{η} {\vec{E}}_{\vert \vert} , {u}_{z} {\vert}_{z = 0 , h} = 0 , \qquad ( 2 )$$

where ε is the fluid permittivity. Integrating the in-plane momentum equation Eq. (1) twice with respect to z and using the slip boundary conditions Eq. (2), we obtain the in-plane velocity field, which is then averaged vertically and leads to the depth-averaged in-plane velocity

$$〈 {\vec{u}}_{\vert \vert} 〉 = - \frac{{h}^{2}}{12 η} {\vec{∇}}_{\vert \vert} p - \frac{ɛ 〈 ζ 〉}{η} {\vec{E}}_{\vert \vert} . \qquad ( 3 )$$

where [symbol] ζ [symbol] is an arithmetic mean value of zeta potential, [symbol] ζ [symbol] =(ζ_{U}+ζ_{L})/2. Applying the two-dimensional divergence to Eq. (3) and using the relation \vec{∇}_{∥}· [symbol] \vec{u}_{∥} [symbol] =0, the velocity is eliminated to obtain an equation in terms of the pressure only,

$${∇}_{\vert \vert}^{2} p = - \frac{12 ɛ}{{h}^{2}} {\vec{E}}_{\vert \vert} \cdot {\vec{∇}}_{\vert \vert} 〈 ζ 〉 , \qquad ( 4 )$$

while applying the normal component of the curl operator to Eq. (3) and using the relation \vec{∇}_{∥}×\vec{∇}_{∥}p=0, the pressure is eliminated to obtain an equation in terms of stream function ψ,

$${∇}_{\vert \vert}^{2} ψ = - \frac{ɛ}{η} ( {\vec{E}}_{\vert \vert} \times {\vec{∇}}_{\vert \vert} 〈 ζ 〉 ) \cdot \hat{z} . \qquad ( 5 )$$

Here ψ(x,y) is the depth-averaged stream function related to the flow field through [symbol] \vec{u}₈₁ [symbol] =(∂ψ/∂y,−∂ψ/∂x). The governing equations Eq. (4) and Eq. (5) are an uncoupled set of Poisson equations for the pressure and the stream function which take into account the effect of non-uniform electroosmotic flow. The inhomogeneous part of Eq. (4) depends on gradients of zeta potential which are parallel to the applied electric field, while the inhomogeneous part of Eq. (5) depends on gradients of zeta potential in a direction normal to the applied electric field.

Of particular interest in the context of this work is the case of a disk-shaped pattern of radius r₀ having a uniform zeta potential of ζᵢₙ, surrounded by a surface having a zeta potential of ζₒᵤₜ,

$$〈 ζ 〉 ( r ) = \{ \begin{matrix}{ζ}_{in} & inside disk \\ {ζ}_{out} & outside disk .\end{matrix} \qquad ( 6 )$$

For the electric field E is directed along the \hat{x} axis, using Eq. (4) and Eq. (6) the resulting pressure distribution reads

$$p ( r , θ ) = \{ \begin{matrix}[ - \frac{6 ɛ E ( {ζ}_{in} - {ζ}_{out} )}{{h}^{2}} {( \frac{{r}_{0}}{r} )}^{2} + \frac{Δ p}{Δ x} {\vert}_{ex} ] r cos θ & r > {r}_{0} \\ [ - \frac{6 ɛ E ( {ζ}_{in} - {ζ}_{out} )}{{h}^{2}} + \frac{Δ p}{Δ x} {\vert}_{ex} ] r cos θ & r \leq {r}_{0} ,\end{matrix} \qquad ( 7 )$$

where Δp/Δx|ₑₓ corresponds to an externally applied pressure gradient in the \hat{x} direction. The corresponding flow field is obtained using Eq. (3), Eq. (6) and Eq. (7)

$$〈 {\vec{u}}_{\vert \vert} 〉 ( r , θ ) = \{ \begin{matrix}- \frac{{h}^{2}}{12 η} [ ( \frac{6 ɛ E ( {ζ}_{in} - {ζ}_{out} )}{{h}^{2}} {( \frac{{r}_{0}}{r} )}^{2} + \frac{12 ɛ E {ζ}_{out}}{{h}^{2}} + \frac{Δ p}{Δ x} {\vert}_{ex} ) cos θ \hat{r} - ( - \frac{6 ɛ E ( {ζ}_{in} - {ζ}_{out} )}{{h}^{2}} {( \frac{{r}_{0}}{r} )}^{2} + \frac{12 ɛ E {ζ}_{out}}{{h}^{2}} + \frac{Δ p}{Δ x} {\vert}_{ex} ) sin θ \hat{θ} ] & r > {r}_{0} \\ - \frac{{h}^{2}}{12 η} [ ( \frac{6 ɛ E ( {ζ}_{in} - {ζ}_{out} )}{{h}^{2}} - \frac{{h}^{2}}{12 η} [ ( \frac{6 ɛ E ( {ζ}_{in} - {ζ}_{out} )}{{h}^{2}} + \frac{12 ɛ E {ζ}_{out}}{{h}^{2}} + \frac{Δ p}{Δ x} {\vert}_{ex} ) sin θ \hat{θ} ] & r \leq {r}_{0} .\end{matrix} \qquad ( 8 )$$

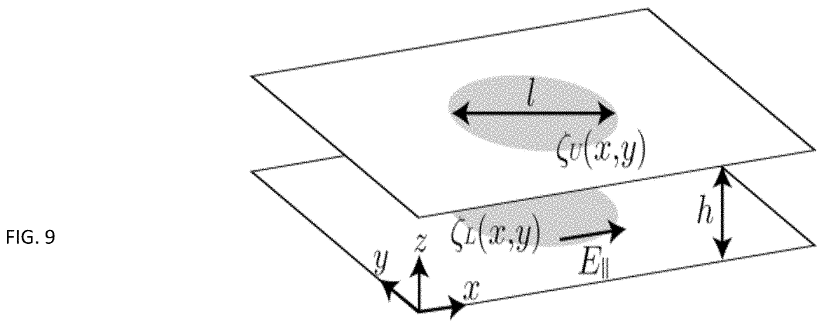

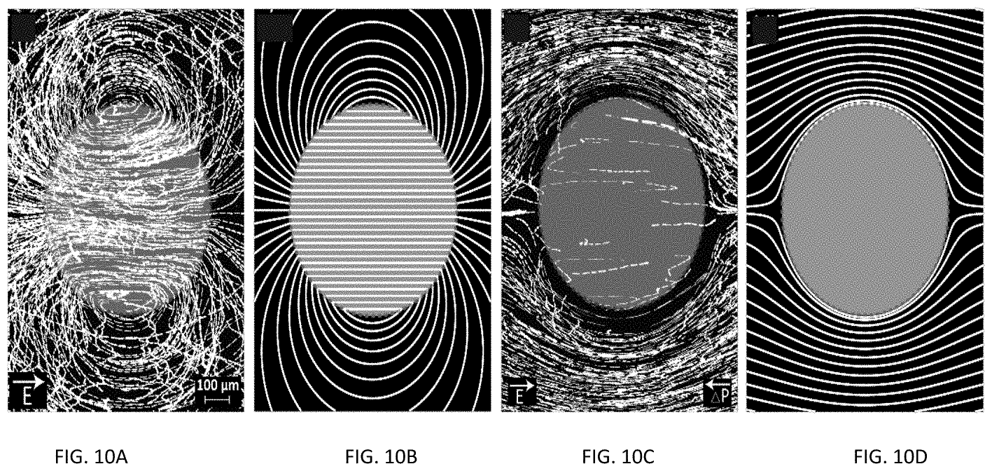

FIG. 10A presents experimental streamlines obtained for the case of a 500 μm diameter disk patterned with PAH (positive change), surrounded by PLL-PEG coating (near neutral). The resulting flow pattern is in good agreement with the analytical result presented in FIG. 10B, based on equation (7) for Δp/Δx|ₑₓ=0, showing dipole flow. FIG. 10C presents the flow pattern for a case where an additional pressure driven flow opposes the electroosmotic flow within the disk, generating streamlines which curve around the disk. This is again in very good agreement with the analytical results presented in FIG. 10D. These results cross validate the theory and experimental results, showing that predicted flow patterns can indeed be implemented, and that patterning by polyelectrolyte is a suitable method for EOF patterning.

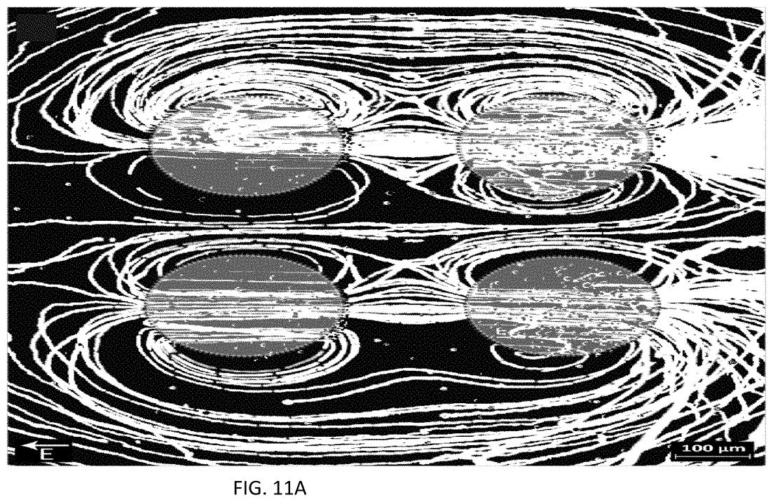

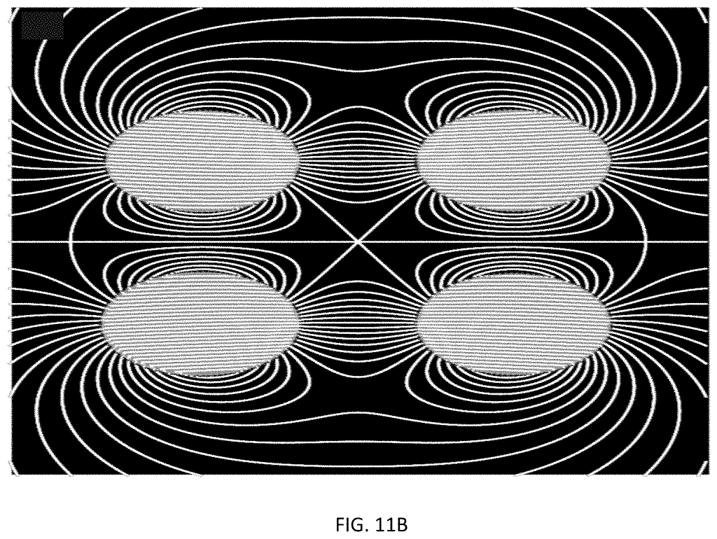

FIGS. 11A-B presents the flow field resulting from four 250 μm disks, whose centers are located 400 μm apart. As shown in FIG. 4b, owing to the linearity of governing equations, the resulting streamlines are a superposition of the individual dipoles. This demonstrates the use of basic elements to construct complex flow patterns.

Zeta Potential Stripes for Separation based on Diffusivity

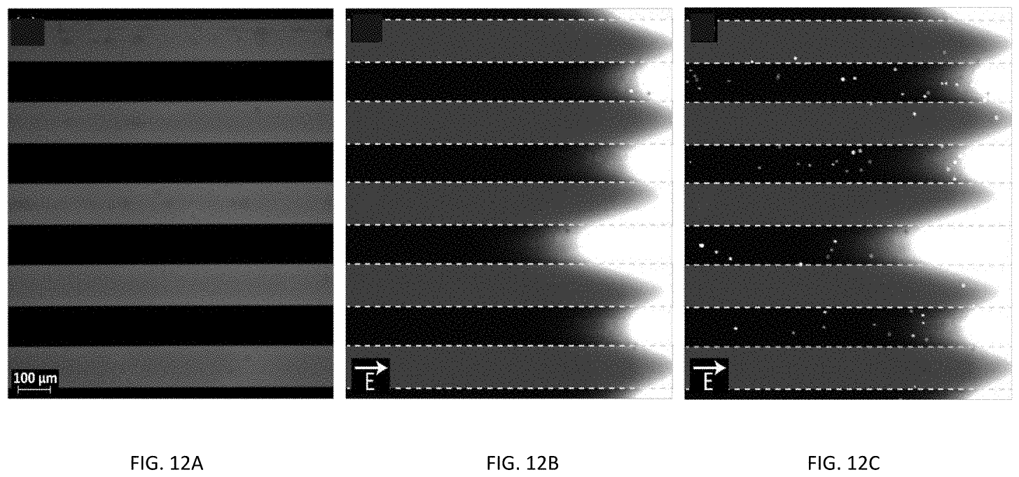

Non-uniform electroosmotic flows can be used not only for transport of fluids, but also to control the dynamics of molecules and particles in the fluid. FIGS. 12A-C demonstrate how particles with different Peclet number follow different trajectories over a pattern made of alternate stripes of positive and negative surface charge (PAH and bare glass, respectively). A sample containing a mixture of high-diffusivity neutral molecules (Rhodamine B with diffusivity 4.2·10⁻¹⁰ m²s⁻¹) was injected and low-diffusivity nearly-neutral (PLL-PEG coated) particles (1 μm beads with diffusivity −4.1·10⁻¹³ m²s⁻¹) to a reservoir connected to the right end of the chamber (not shown). As shown in FIG. 12B, upon application of an electric field parallel to the strips, Rhodamine molecules are carried by the negative EOF strips in the channel, but quickly diffuse into positive EOF stripes resulting in a dispersed yet stationary concentration profile. In contrast, due to their low diffusivity, the beads experience the same EOF (i.e. travel over the same stripe) for much longer time before sampling a different stripe. This results in effective diffusivity-based separation.

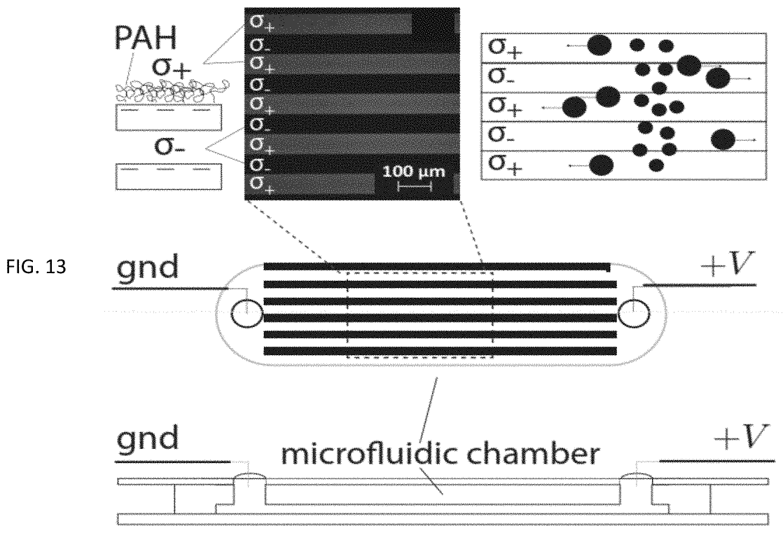

FIG. 13 shows another illustration of the working principle of this separation method. As described above, the pattern the bottom of a fluidic chamber with stripes of alternating sign (i.e. positive/negative) zeta-potentials. Upon application of an external electric field parallel to these stripes, an alternating-directions electroosmotic flow (EOF) pattern is formed, with zero net flow. High-diffusivity molecules introduced into the flow rapidly diffuse across stripes and experience an average zero velocity, whereas low-diffusivity molecules remain on single stripes and therefore advect through the microfluidic chamber. As advection distance scales linearly with time, and diffusion distance with the square root of time, effective separation is achieved.

Two modes of operation may be proposed: (a) continuous-injection, and (a) finite-injection. In the continuous-injection mode, the analytes are placed in one of the cell reservoir and continuously brought into the microfluidic chamber. While in the finite-injection mode, a band containing the analytes is injected into the reservoir followed by activation of the electric field.

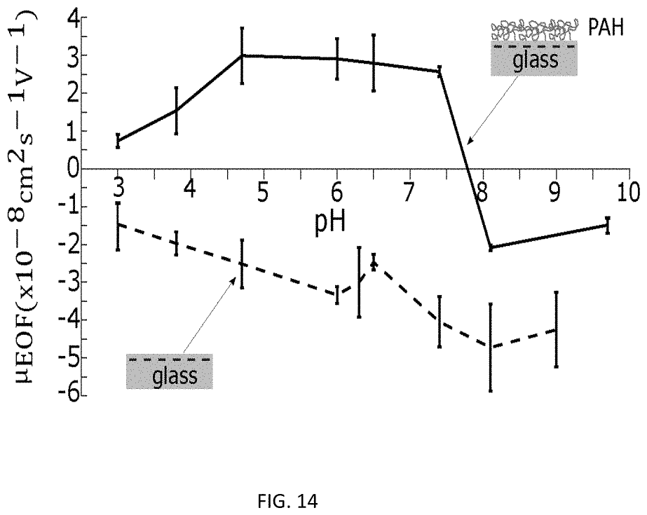

The working point of our buffers according to FIG. 14 that presents measurements of the wall electroosmotic mobility as a function of pH for native and PAH-coated glass surfaces was selected. The strongest contrast between native and wall-coated mobilities is obtained between pH 4.5 and 7.5.

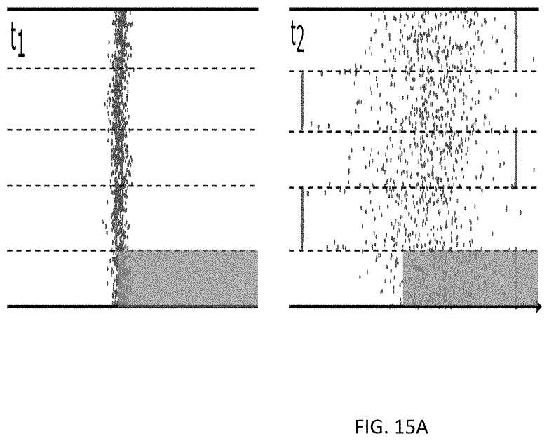

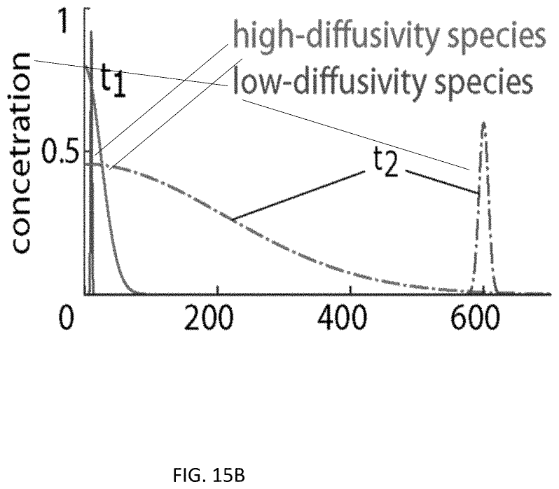

FIG. 15A-B present Monte Carlo simulations for a finite-injection mode, where the sample to be separated is injected as a finite-size band into the chamber followed by the activation of the electric field. The separation is simulates 15 μm cells (D=3.3·10⁻¹⁴ m²s⁻¹) from proteins (D=7.8·10⁻¹¹ m²s⁻¹), showing that such devices would be capable of nearly 97% extraction efficiency in separating cell with 96% purity, in 2 minutes, using moderate electrical fields of 20 V/cm.

### Example 3

### Working Principles

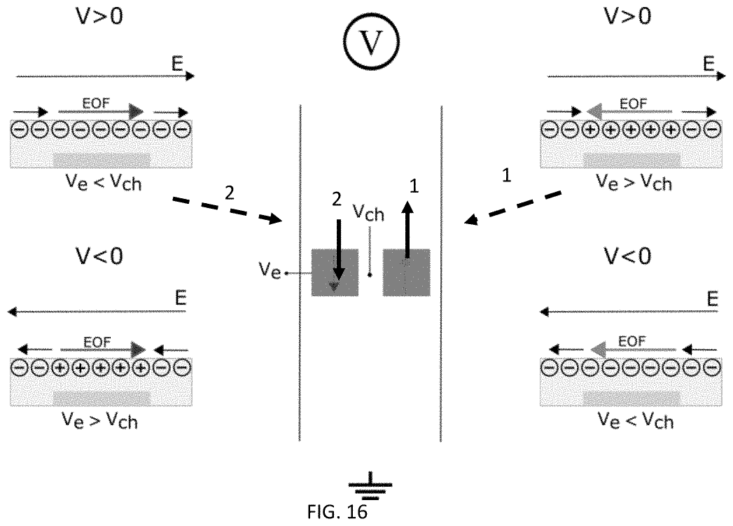

Reference is made to FIG. 16 shows the working principle of creating opposite flow streamlines using two patterned electrodes covered with a dielectric. Electrode 1 and 2 generate streamlines pointing downward (left panel) and upward (right panel), respectively. In the main channel (middle panel), two external electrodes in direct contact with the liquid drive the electric field inside the channel using an AC squared voltage signal, oscillating between V and −V. Because the voltage drops linearly along the channel, the bulk voltage in the proximity of the patterned electrodes is V_{ch}, which absolute value is |Vch|<|V|. Electrode 1 and 2 are driven with an AC potential, in phase and with the same frequency of the AC field in the main channel. On electrode 1, the amplitude of the signal is smaller than the amplitude generated in the bulk (2V_{ch}), generating a surface charge which is negative when the electric field is pointing downwards and positive when the electric field is pointing upwards. On electrode 2, the amplitude of the signal is bigger than the amplitude generated in the bulk (2V_{ch}), generating a surface charge which is positive when the electric field is pointing downwards and negative when the electric field is pointing upwards. Because the EOF velocity is directly proportional to ζE, where E is the electric field and ζ is the zeta potential which is proportional to the voltage difference V_{ch}−Vₑ, the EOF velocity generated by electrode 1 and 2 are always directly downstream and upstream, respectively.

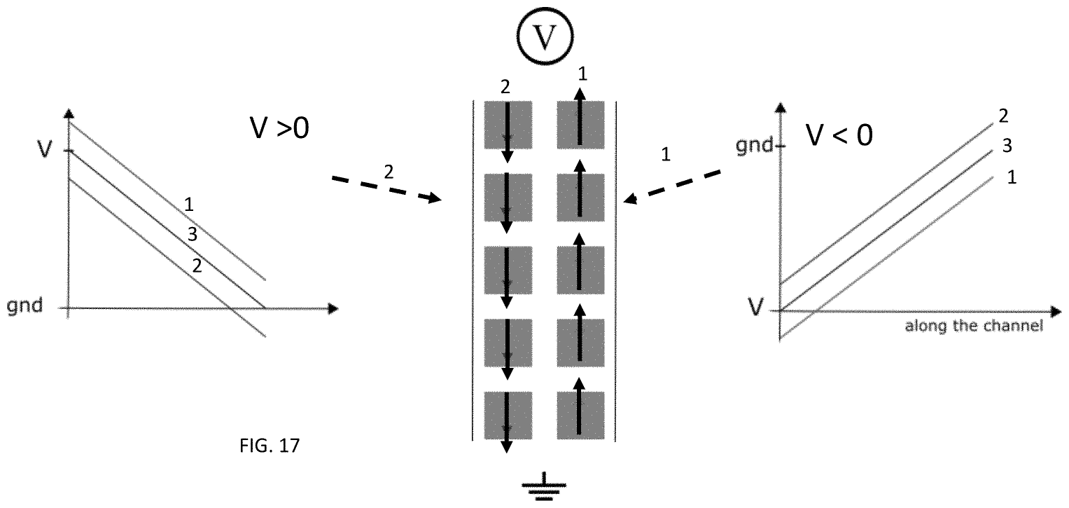

FIG. 17 shows the working principle of creating opposite streamlines using an array of electrodes. Because the potential drops linearly in the main channel, each patterned electrode will experience a different bulk potential. Therefore, the amplitude of the AC signal applied to each electrode should also drop linearly along the channel.

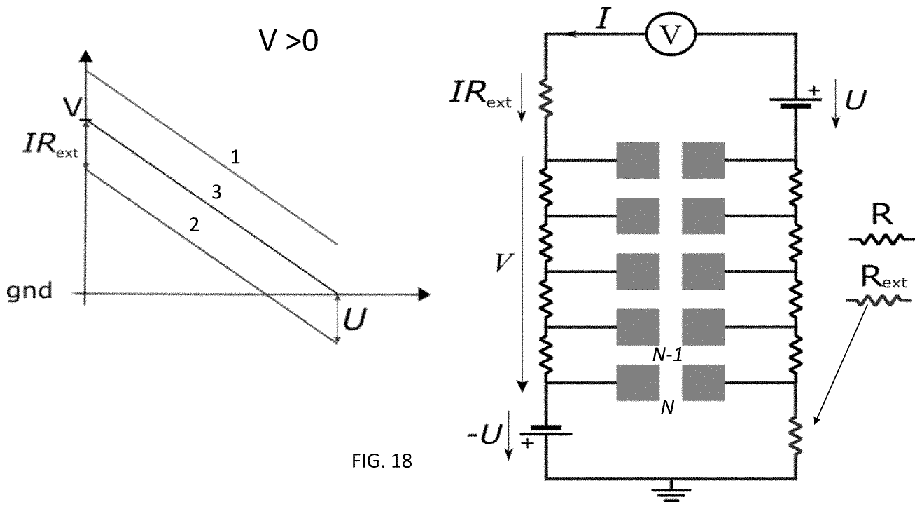

FIG. 18 shows an exemplary circuitry driving a system composed of an array of electrode to create opposite flows. In this configuration, the power supply used to drive the electric field in the main channel is also used to drive the potential AC signal on all the patterned electrodes. The potential drop among the electrodes is generated by a series of potential divider that can be either external (ext) or patterned on the surface. The offset between the potential profile in the main channel and the one applied to the electrodes is provided by two external power supplier (U) connected in series with the circuit that drive the electrode array. The potentials values, U, and V is determined according to the following equations:

$$\{ \begin{matrix}{V}_{N - 1} - {V}_{N} = \frac{V}{N - 1} = \frac{V + U}{{R}_{ext} + ( N - 1 ) R} R \\ U = {IR}_{ext} = \frac{V + U}{{R}_{ext} + ( N - 1 ) R} {R}_{ext} \end{matrix}$$

giving:

$${R}_{ext} = \frac{U ( N - 1 )}{V} R$$

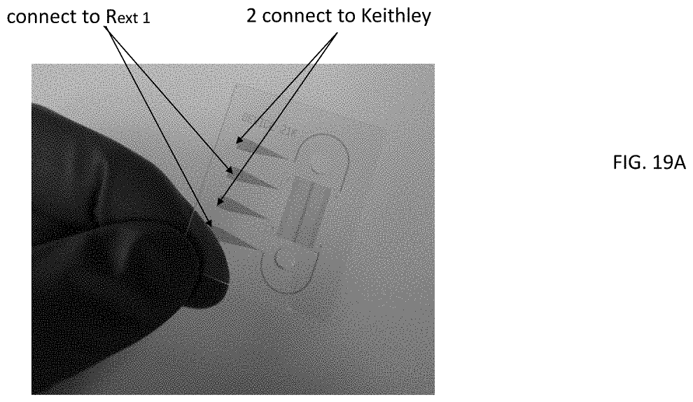

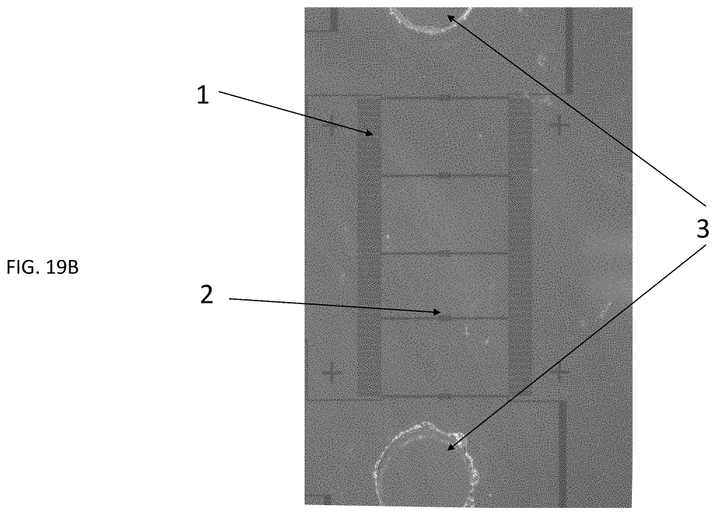

FIGS. 19A-B show images of devices with 8 electrodes. The electrodes are made of: 2 nm Ti, 2 nm Pt, or 2 nm Ti with a dielectric coating of: 800 nm SiO₂.

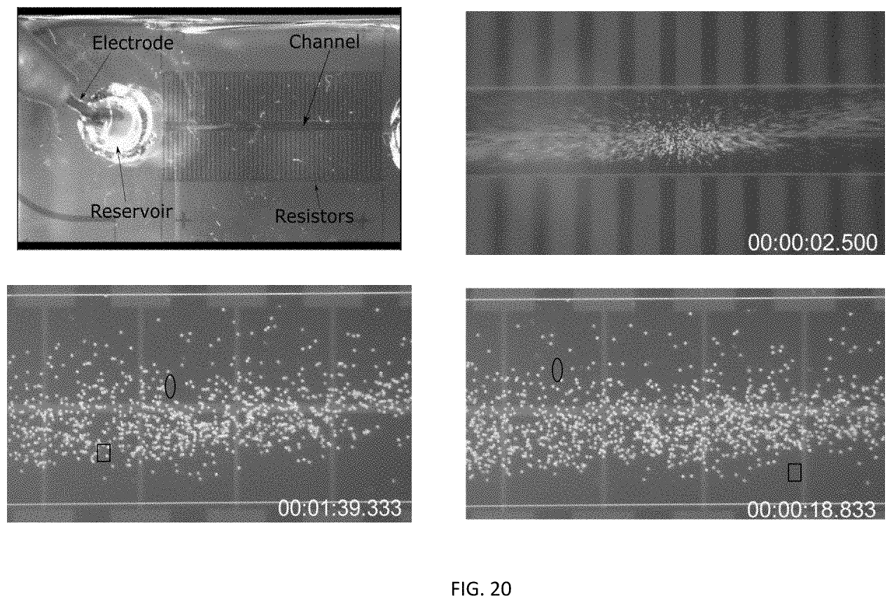

FIG. 20 shows experimental data of a working device (serial snapshots images with the indicated time). The flow is observed using 1 um beads as tracer Conditions: main channel: 50 V; Channel—electrodes: 19 V ;Frequency: 25 Hz; Buffer: 10 mM Acetic, 1 mM NaOH, pH 3.8; Beads: 5 μm.

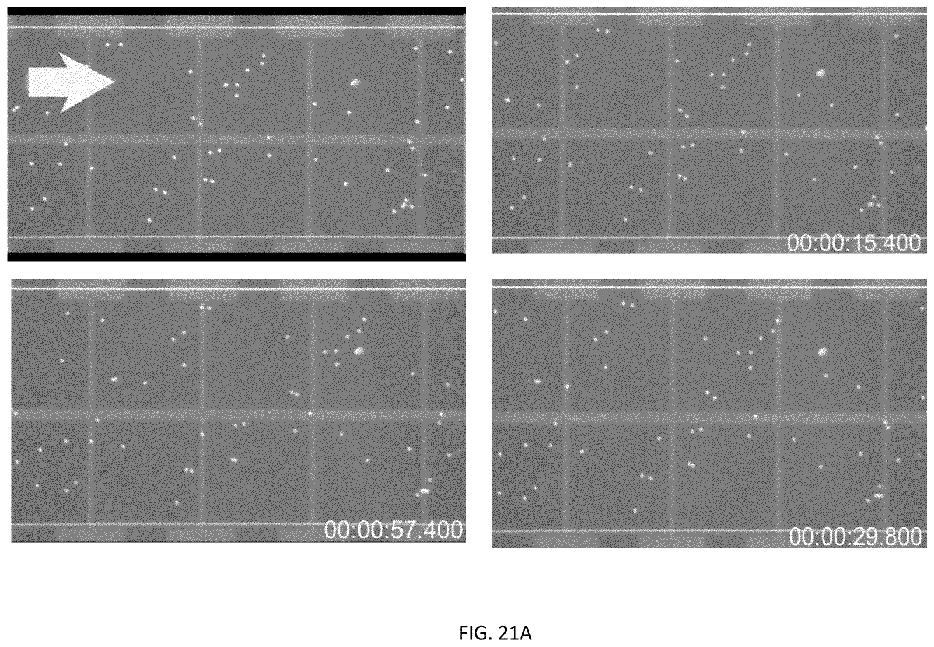

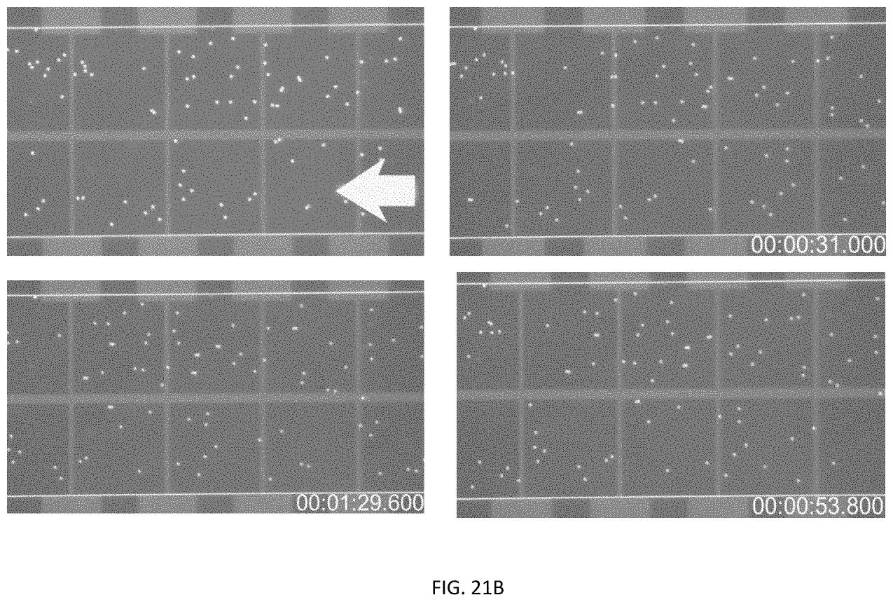

FIG. 21A shows further experimental data of another working device (serial snapshots images with the indicated time). Conditions: main channel: 50 V; Channel—electrodes: 19V Frequency: 25 Hz; Buffer: 10 mM Lactic, 5 mM NaOH, pH 3.8; Beads: 5 μm.

FIG. 21B shows further experimental data of another working device (serial snapshots images with the indicated time) of the opposite direction.

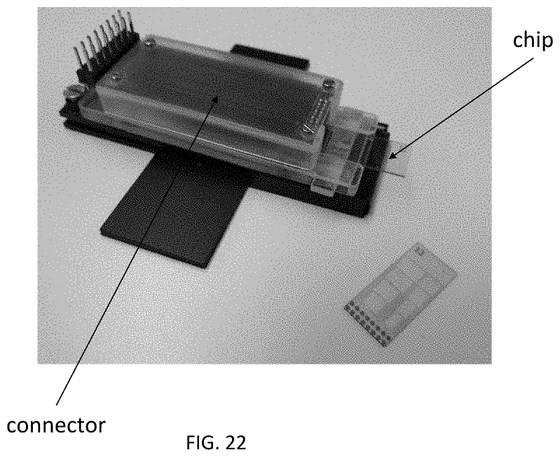

FIG. 22 shows a photographic image of a non-limiting exemplary device.

### Example 4

### Manufacturing and Characterization of a Non-Limiting Device

In an exemplary device, for the purpose of microscale flow control, complex patterns were created, including ones containing isolated regions. An exemplary device was manufactured as set forth below and as illustrated by FIG. 1. The exemplary device in a form of Hele-Shaw chamber of thickness h and length L was filled with an electrolyte in direct contact with a ground electrode (101) and a driving electrode (102). The floor of the chamber (100) contains one or more embedded electrodes (gate electrode 105B) with a characteristic dimension r₀, located at a distance xₑₗ from the ground electrode. Each gate electrode is independently controllable and is configured to generate a positive or a negative surface potential, as described hereinabove (such as in Example 3). The gate electrode is electrically insulated from the electrolyte by a dielectric layer (FIG. 16) of thickness d and dielectric constant ε_{d}. The driving and the gate electrode were actuated with an AC potential at a frequency ω and amplitudes ϕᵢ, Vᵢ(t)=ϕᵢƒ(ωt) where the subscript i indicates either the external (ex) or the gate electrode (el) potential.

Central to the operation of the device is the ability to maintain capacitive charging over the gate electrode for a large number of charge and discharge cycles under high driving electric fields (order of 100 V/cm). Clearly, a thick dielectric layer would be ideal to insulate the electrode against Faradaic currents, thus preventing bubble formation and pH changes resulting from electrolysis. However, the thickness of the dielectric layer should also be tuned to maximize the effect of the gate electrode on the induced zeta potential. A good approximation for the surface zeta potential as a function of Δϕ can be obtained from a capacitor model accounting for the capacitance of the EDL (C_{ELD}=εₗA/λ_{EDL}) in series with the dielectric capacitance (C_{d}=ε_{d}A/d),

$$ζ = {ζ}_{0} + \frac{{C}_{d}}{{C}_{EDL}} Δφ = {ζ}_{0} + \frac{{λ}_{EDL}}{{ɛ}_{l}} {ɛ}_{d} \frac{Δφ}{d} ,$$

where ζ₀ is the native zeta potential of the surface. Therefore, the most effective field-effect electro-osmosis (FEEO) can be expected for a dielectric with the smallest possible thickness d and the largest possible permittivity ε_{d}. The best dielectrics can be obtained in standard microfabrication processes exhibits dielectric breakdown values on the order of 1 V/nm. Given that the EOF driving voltages in this exemplary system are in the range of 100-400 V, a 500 nm layer of a high quality dielectric is expected to withstand such potential differences.

The gate electrode having the dielectric coting applied thereto was manufactured as described hereinbelow. A 0.5 mm-tick, 4′ wafer double-polished borosilicate glass (Plan Optik AG) was used as the substrate. The metal structures of the gate electrodes were manufactured by a lift-off process, depositing a sandwiched metal layer of 2 nm Ti-2 nm Pt-2 nm Ti by physical evaporation (BAK501, Evatec AG). Two layers of titanium were used to improve the adhesion of the metal layers to both the substrate and the dielectric; the platinum layer was used since it is resistant to hydrofluoric acid (HF) and acts as a stopping layer during the etching process for opening the electrical connections. The metal layer thickness is 6 nm, thin enough to allow optical transmittance in the visible spectrum, enabling visualization of fluorescent beads using an inverted epifluorescence microscopy.

The dielectric layer was manufactured by deposition of 500 nm of silicon oxynitride (SiON) followed by 100 nm of silicon dioxide (SiO₂) by plasma-enhanced chemical vapor deposition (PECVD). To test different dielectric materials PECVD process was used for SiO₂, SiON and silicon nitride (SiNₓ), or atomic layer deposition (ADL), for SiO₂, hafnium dioxide (HfO₂) and alumina (Al₂O₃).

The electrical contact was then exposed by etching the dielectric over the driving electrodes and the pads by using HF (for SiO₂, SiON, HfO₂ and Al₂O₃) or dry etching for SiNₓ. The dielectric is inherently in an asymmetric configuration as it is in contact with a metal on one side and an electrolyte on the other. Because under an AC field the dielectric will be subjected to both positive and negative voltages, it is important to measure its breakdown for both cases.

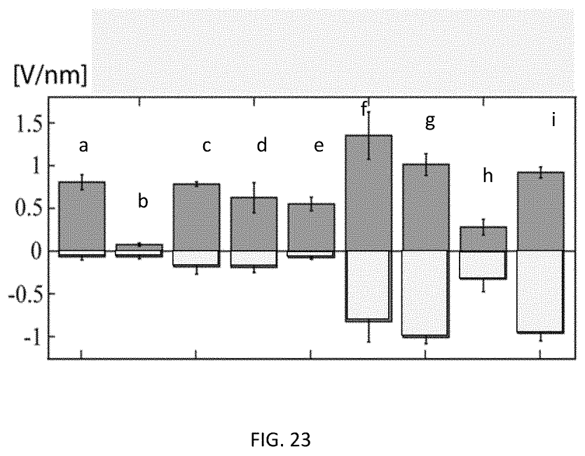

FIG. 23 shows the measured dielectric breakdown field (breakdown voltage normalized by the dielectric thickness) for different dielectric coatings deposited with PECVD.

Pure SiNₓ shows poor dielectric resistance, holding only up to approximately 0.1 V/nm.

SiO₂ performs significantly better for positive voltages, yet exhibits a clear asymmetry with a very low breakdown threshold for negative voltages (˜0.1 V/nm). Doubling the thickness of this layer to 1 μm does not show an improvement. A two layer composition of SiNx on top of SiO₂ provides a significant improvement in both breakdown voltage and symmetry; however, it was noted that flipping the order of the layers is not equivalent and yields poor performance, even for large thicknesses. SiO₂ deposition using tetraethyl orthosilicate (TEOS) precursors show better symmetry but a lower absolute breakdown field.

The dielectric that showed the best performance is SiON, yielding a 1 V/nm breakdown voltage for both positive and negative applied voltages. Therefore, 500 nm thick SiON layer covered with an additional 100 nm layer of SiO₂ was preferentially used for manufacturing the dielectric layer of the device.

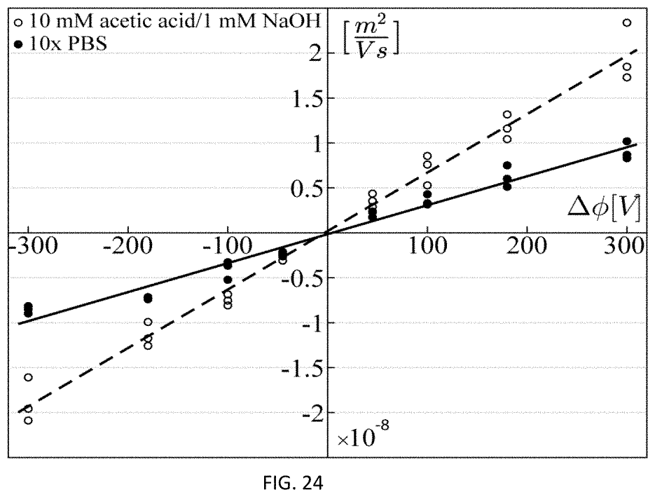

FIG. 24 represents the measured time averaged EO wall mobility (μ_{EO}^{av}=u_{EOF}^{av}/E) as a function of the applied amplitude difference Δϕ. In this range of applied potentials, both curves show a linear dependence, with R² values of 0.96 and 0.99, respectively. The measurements of the EO wall mobility were performed using a straight channel with an array of gate electrodes and fluorescent beads to trace the flow; the EO wall mobility is derived by the depth-average velocity obtained by Particle image velocimetry (PIV).

While, as expected, higher EO wall mobility is obtained using a low pH buffer (10 mM acetic acid and 1 mM NaOH, pH 3.8), the use of physiological pH buffer (10 times diluted PBS) also provides significant EO mobility, indicating the potential use of AC driven FEEO flow patterning for biochemical applications.

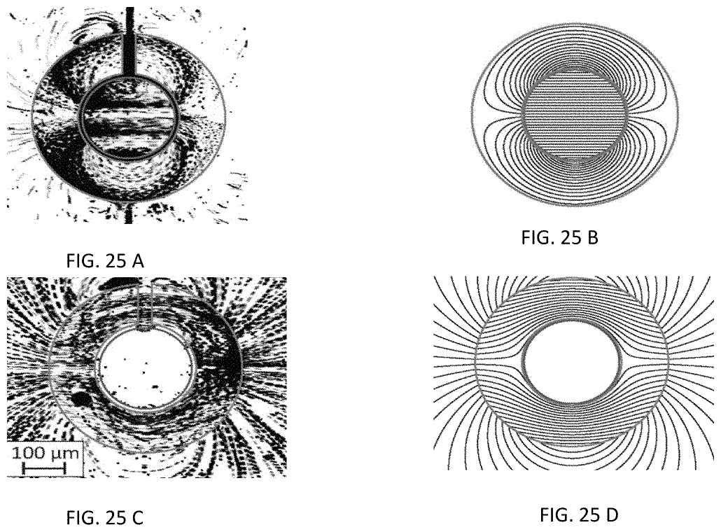

FIGS. 25 (A-D) show analytical predictions and experimental visualization images of flow streamlines generated by a 200 μm-diameter disk-shaped electrode surrounded by a 400 μm outer diameter annulus, for different combinations. FIG. 25 A, FIG. 25 C: at t1, the potential amplitude ratio of the two gate electrodes is set such that outside the annulus the two EOF dipoles flows cancel each other (inner Δϕ=−120 V and outer Δϕ=40 V), resulting in an isolated region of recirculating flow surrounded by a quiescent liquid. FIG. 25 B, FIG. 25 D at t2, Δϕ of the disk electrode was set to zero, resulting a finite stagnation volume surrounded by flow. The amplitude in the channel for both case is Δϕex=300 V, and approximately Δϕch=160 V in the electrode region. This demonstrates the use of disk within a disk electrode to construct complex flow patterns.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A system comprising:
at least one microfluidic chamber;
a first driving electrode and a second driving electrode arranged on opposite ends of said chamber and configured to generate a voltage across a fluid volume in said chamber, said fluid being a liquid comprising an electrolyte; and
any one of: (i) one or more gate electrodes; and (ii) a region of a charged material, disposed on or within at least one wall of said microfluidic chamber, so as to provide a plurality of surface charges located within or adjacent to said fluid volume.

2. The system of claim 1, wherein each of said one or more gate electrodes is independently controlled.

3. The system of claim 1, wherein said one or more gate electrodes are in a form of an array of electrodes.

4. The system of claim 1, comprising a dielectric layer deposited between said one or more gate electrodes and the fluid volume, wherein said dielectric layer comprises one or more dielectric materials selected from: silicon oxonitride (SiON), silica, alumina, silicon nitride, hafnium oxide, poly(p-xylylene), and poly-dimethylsiloxane (PDMS) or any combination thereof, and wherein said dielectric layer has a thickness of 1 nm to 1 mm.

5. The system of claim 1, comprising an alternating current (AC) source in operable communication with (i) the first driving electrode, and with the second driving electrode, and (ii) with said one or more gate electrodes, and wherein said system further comprises a regulator, configured to synchronize the amplitudes of the AC applied to the first and the second driving electrodes and to the one or more gate electrodes.

6. The system of claim 1, further comprising a control unit configured to modulate a charge of at least one of said one or more gate electrodes, thus modulating charge distribution on a surface of said fluid.

7. The system of claim 1, wherein said at least one wall comprises a material having an electrical conductivity of less than 1 nS/m, and wherein said at least one wall comprises a material selected from:
polydimethylsiloxane (PDMS), polymethyl methacrylate (PMMA), cyclic olefin copolymer (COC), glass, or any combination thereof.

8. The system of claim 1, wherein said charged material comprises one or more materials selected from: a charged self-assembled monolayer, a charged polymer, a charged cross-linked organosilicate; an amino acid, a peptide, a protein, a nucleotide, a nucleoside, DNA, oxidized silicon surface; ceramics, oxides, a conductive layer, and a metal including any combinations or derivates thereof.

9. The system of claim 1, wherein said charged material comprises a polymer selected from epoxy-based polymer, poly(allylamine hydrochloride) (PAH), poly(styrene sulphonate) (PSS), poly(diallyldimethylammonium chloride) (PDDA), branched poly(ethylenimine) (PEI), poly(ethylene glycol) (PEG), and poly-L-lysine (PLL).

10. The system of claim 1, wherein said liquid comprises Newtonian liquid, non-Newtonian liquid, or a combination thereof.

11. The system of claim 1, wherein the first and the second driving electrodes are connected to a source of direct current (DC).

12. The system of claim 1, wherein said fluid has a pH between 3 and 8 and wherein a concentration of said electrolyte within said fluid is less than 100 mM.

13. A method of patterning an electroosmotic flow (EOF), comprising the steps of:
(i) providing the system of claim 1;
(ii) generating a voltage via the first driving electrode and the second driving electrode so as to provide an electrical field within said liquid; wherein the pattern is determined according to the surface charges, thereby patterning the EOF.

14. The method of claim 13, wherein said pattern is characterized by a linear and/or a non-linear EOF.

15. The method of claim 13, wherein each charge of said plurality of surface charges is independently controlled, thereby predetermining said pattern and/or direction of the EOF.
